(19) United States
(12) Patent Application Publication
(10) Pub. No.: US 2018/0165646 A1
(43) Pub. Date: Jun. 14, 2018

(54) WORK ATTACHED PEOPLE MANAGEMENT

(71) Applicant: COGWARE PTY LTD., Melbourne (AU)

(72) Inventor: Jonathon Windust, Melbourne (AU)

(21) Appl. No.: 15/834,854

(22) Filed: Dec. 7, 2017

Related U.S. Application Data
(60) Provisional application No. 62/431,636, filed on Dec. 8, 2016.

(51) Int. Cl. G06Q 10/10; G06Q 10/06

(52) U.S. Cl. CPC G06Q 10/105; G06Q 10/06398

(57) ABSTRACT

Disclosed is a computer implemented method of managing information between users. The method includes providing one or more People Management Objects (PMO's), where the PMO's including one or more users, and the PMO's are adapted to collect information from the one or more users. The PMO's are then associating the PMO's with one or more additional PMO's; and the PMO's are output for the PMOs for the users to participate.

### CROSS-REFERENCED APPLICATION

This application claims priority to U.S. Provisional Patent Application Ser. No. 62/431,636, filed Dec. 8, 2016, the subject matter of which is incorporated herein in its entirety as if fully set forth verbatim herein.

### TECHNICAL FIELD

The present disclosure relates people management and in particular to a method and system for managing information between users.

### BACKGROUND OF DISCLOSURE

People management systems seek to simplify human resources processes and can range from automating payroll, to recruitment to performance review systems.

Many existing people management systems such as those provided by SAP and Oracle are largely directed to payroll and administrative HR functions like leave management but there has been limited success in controlling people management such as performance management.

Current people management systems realize only a small percentage of their potential. They remain largely underutilized with some processes, for instance performance management, having marginal utility at best.

Compounding this, the world of work is changing with today's organizations becoming less hierarchical and more collaborative. Average tenure is decreasing while freelancing is becoming commonplace. The key problem for people management in this new world of work is that current systems are built around old world concepts. They are largely ineffective in this more agile emerging future.

In this rapidly emerging new world of work, current people management systems do not work. Systems that currently have marginal utility in many of the people management functions, cannot possibly meet the needs of a more agile and collaborative future.

### SUMMARY OF DISCLOSURE

According to a first aspect, the present disclosure provides, a computer implemented method of managing information between users, the method including:

a. providing one or more People Management Objects (PMO's), the PMO's including one or more users, and the PMO's adapted to collect information from the one or more users;
b. associating the PMO's with one or more additional PMO's; and
c. outputting the PMOs for the users to participate.

Preferably, associating includes connecting, via an edge connection the one or more PMOs to one or more further PMO's. A relationship may also be created between one or more PMOs to one or more further PMO's. The relationship may take a parent-child relationship form.

The method may further include the step of reproducing one or more objects for use in a separate PMO such as for use as a template for example.

Preferably, the method further includes the step of aggregating data from one or more PMO's or between one or more PMO's. The data may be aggregated between one or more PMO's and a user profile associated with a user.

Aggregation may occur between PMO's and a user profile associated with a user. For example, if you have a Task or Goal, the connected child Review object can be aggregated to provide a summary and aggregate rating within the Task or Goal. Advantageously, connections between objects enable greater meaning to be formed.

A PMO may include any one or more of a Goal MO, Review MO, Skill MO, Feedback MO or Learning MO.

Preferably, the method further includes the step of providing one or more Work Objects. A PMO may be associated with the one or more Work Objects. Associating may further include creating a relationship between one or more PMOs to Work Objects.

A Work Object may include one or more of a Conversation, Task or Plan.

The method may further include the step of providing an External Information Object and further associating a PMO with an External Information Object. An External Information Object may include one or more of a description of the external information, external information URL and/or an external information reference.

Preferably each of the Goal MO Review MO, Learning MO, Skill MO and Feedback MO, includes a title, subject participants, other participants, one or more attachments, one or more discussions and one or more connections one or more other PMO's. The one or more connections may be parent, child or undirected connections.

The method may further include the step of providing special purpose data associated with a PMO. Special purpose data includes one or more of start dates and end dates, review, rating, recognition, rich memo supporting formatted text, tables, pictures, video, description, measures, progress indicator, outcomes, learning content, evidence requirements, assessment criteria, notes, status, external information reference, or a URL.

Preferably a Goal MO further includes one or more of Goal description, Target Date, Measurement and Progress Indicator.

A Feedback MO further includes further includes a Feedback memo supporting formatted text, tables, pictures and video and a feedback type. The feedback type may include for example, recognition, a record of one-on-one conversation or general feedback.

A Review MO further includes a rich memo supporting formatted text, tables, pictures, video, a rating or numerical result. A Learning MO further includes a description of learning, outcomes description, progress indicator, learning content memo supporting formatted text, tables, pictures, video. The Learning MO further includes links to industry standard eLearning content, wherein the eLearning content includes SCORM, AICC and TinCan.

Preferably a Skill MO further includes, a skill description, a metric for skill demonstration, learning required to develop the skill, specification for skill assessment.

Advantageously, the present disclosure connects the functions of people management to work as it is occurring or being planned. The disclosure enables agility by putting tools in the hands of people when they need them and by removing the artificial divide between people management and work.

### BRIEF DESCRIPTION OF DRAWINGS

FIG. 1 is a flow chart illustrating the people management system according to an embodiment of the present disclosure;

FIG. 2 is a schematic diagram illustrating connections between one or more Work Objects and People Management Objects according to an embodiment of the disclosure;

FIG. 3 is an example user interface of the user interface for a people management objects being a user profile;

FIG. 4 is an example user interface showing a learning section of the user profile shown in FIG. 3;

FIG. 5 is an example user interface showing the goals interface of the user profile of FIG. 3;

FIG. 6 is an example user interface showing the reviews section of the user profile of FIG. 3;

FIG. 7 is an example user interface showing the skills section of the user profile of FIG. 3;

FIG. 8 is an example user interface showing a feedback section of the user profile of FIG. 3;

FIG. 9 is an example user interface showing common object elements between people management objects;

FIG. 10 is an example user interface of a people management object in the form of a review object;

FIG. 11 is an example user interface of a feedback object;

FIG. 12 is an example user interface illustrating a goal object;

FIG. 13 is an example user interface illustrating a learning object;

FIG. 14 is an example user interface illustrating a skill object;

FIG. 15 is an example user interface illustrating a conversation object;

FIG. 16 is an example user interface illustrating a task object;

FIG. 17 is an example user interface illustrating a plan object;

FIG. 18a is an example user interface illustrating an external object;

FIG. 18b is an example user interface illustrating an external object in the form of an email client to provide a feedback object;

FIG. 18c is a further example user interface illustrating an external object in the form of an email client to provide a feedback object;

FIG. 19 is an example flowchart illustrating how an object template is copied according to an embodiment of the present disclosure;

FIG. 20 is a flow chart illustrating a review addition mechanism according to an embodiment of the present disclosure;

FIG. 21 is a flow chart illustrating a feedback addition mechanism according to an embodiment of the present disclosure;

FIG. 22 is a flow chart illustrating an object connection mechanism according to an embodiment of the present disclosure;

FIG. 23 is a flow chart illustrating a skill learning assessment according to an embodiment of the present disclosure;

FIG. 24 is a flow chart illustrating a status calculation method according to an embodiment of the present disclosure;

FIG. 25 is a flow chart illustrating an External Information Object connection method according to an embodiment of the present disclosure;

FIG. 26 is a flow chart illustrating a review rating aggregation method according to an embodiment of the present disclosure;

FIG. 27 is a flow chart illustrating a skill assessment method according to an embodiment of the present disclosure;

FIG. 28 is a flow chart illustrating a learning templating usage tracking method according to an embodiment of the present disclosure; and

FIG. 29 is a flow chart illustrating a user profile learning section suggestions method according to an embodiment of the present disclosure.

### DETAILED DESCRIPTION

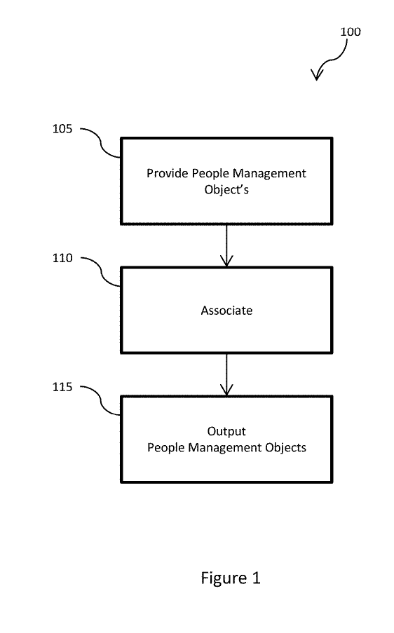

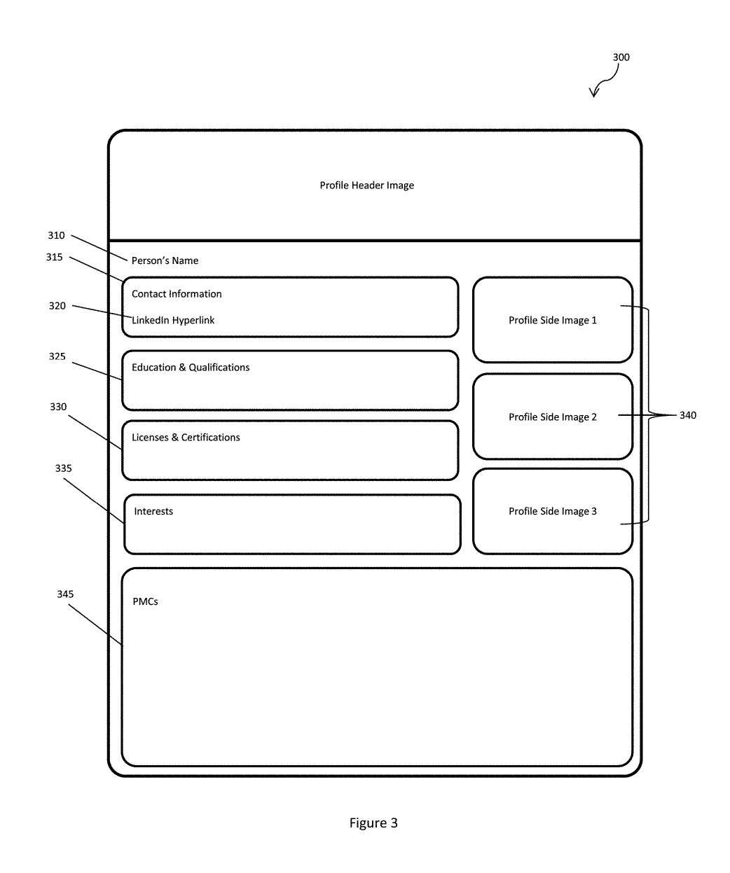

FIG. 1 is a flow diagram illustrating the system and method of the present disclosure. The method 100 includes at step 105 providing one or more people management objects, the people management objects including one or more participants and the people management objects being adapted to collect information from the one or more participants. The control then moves to 110 where the people management objects are connected to one or more other people management objects or other information. It will be appreciated that at step 110 the People Management Objects may be connected by an edge connection to one or more further people management objects or to one or more Work Objects or to one or more External Information Objects. The People Management Object may include any one or more of a goal management object, review management object, skill management object, feedback management object, learning management object of the like and each of these may be associated with each other and a relationship may be provided between them such as a parent child relationship. Control then moves to step 115 where the people management objects are output for the users to participate. The output may be further provided to a user profile for example as will be further described with reference to FIGS. 3 to 18c.

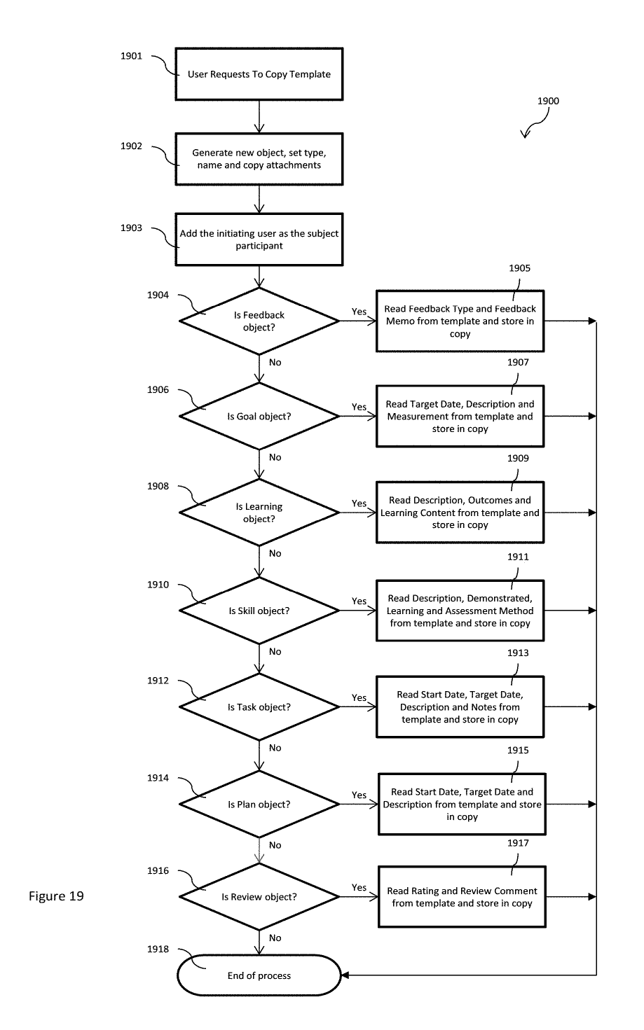

Depending on the type of people management object, the method controls and is carried out in further steps which will be described with reference to FIGS. 19 to 29.

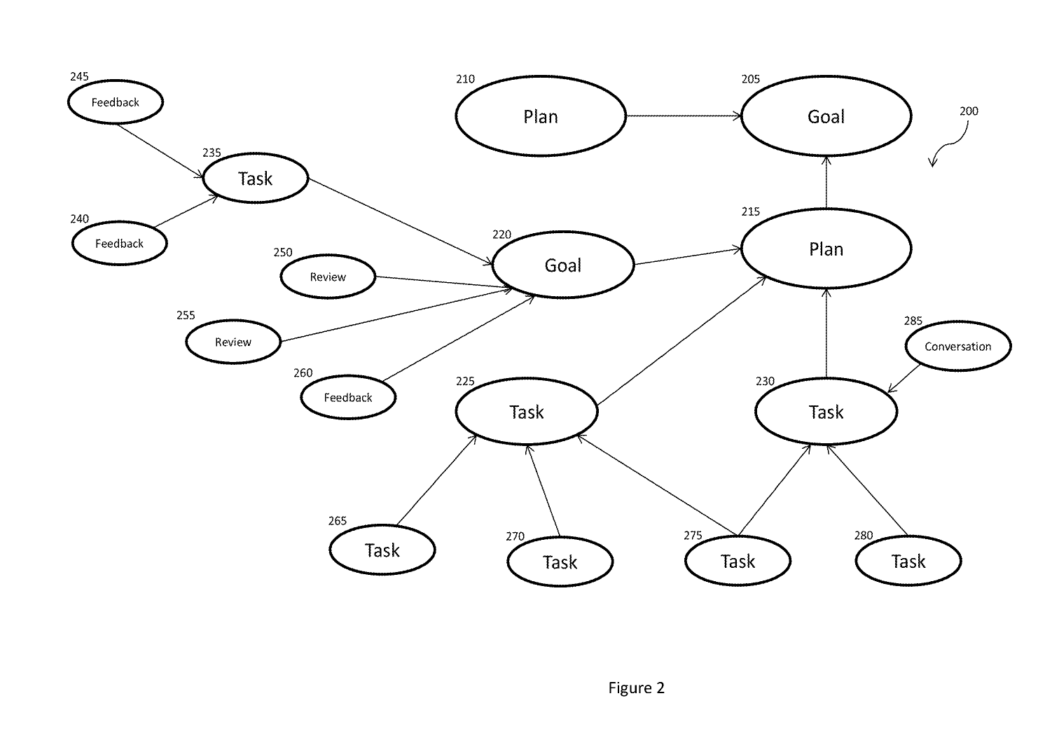

FIG. 2 is a schematic diagram illustrating how the people management objects connect together in order to form greater meaning. In the schematic diagram 200 a number of people management objects are shown 205 to 285, which may be interconnected.

For example, a goal object 205 has two plans 210 and 215 which are connected to the goal object 205 as child objects. For example, the plans 210 and 215 may be considered to be the work that is needed to be done in order to achieve the goal represented by the goal 205. The plan object 215 itself has a goal object 220 connected to it as a child relationship, plan 215 also has two task objects 225 and 230 also connected to it in a child relationship. Collectively, the goals associated with goal 220 and task associated with task objects 225 and 230 can be considered to be necessary or component parts of the plan associated with plan objects 215. The task associated with task object 275 illustrates an important feature of the present disclosure and that is that any object can be connected to any number of other objects. The task associated with task object 275 is connected in a child relationship to both the task associated with task objects 225 and 230 respectively. This in affect means that task 275 forms part of the work for both tasks 225 and 230 to be completed.

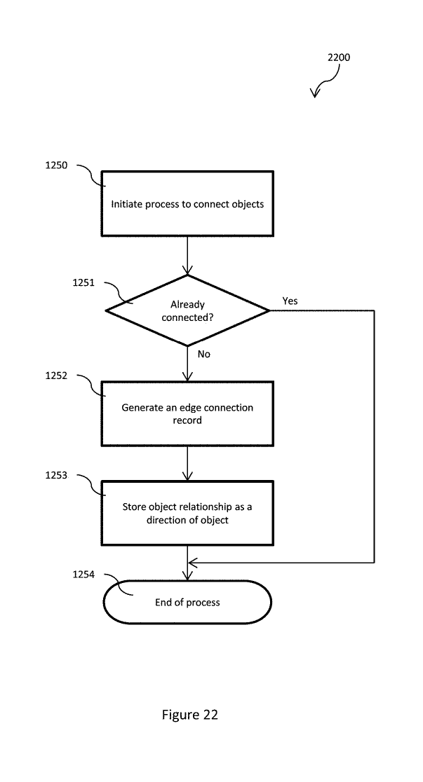

The goal associated with goal object 220 has two review objects 250 and 255 connected in a child relationship. This means that they are reviews of the achievements for the goal associated with goal object 220. The goal associate with goal object 220 also has a feedback object 260 connected in a child relationship. This means that the feedback associated with feedback object 260 is related to the goal associated with goal object 220. The way in which one objected is connected to another will be described further with reference to FIG. 22.

It will be convenient to describe operation of the system and method of the present disclosure from the point of view of a human resources function in an organization but it will be appreciated that the present disclosure can be applied in other situations.

FIG. 3 is an example user interface 300 illustrating the operation of a user profile within a people management object.

The people management object contains information relating to people management information about one or more people. The people may be involved in an organization or the like. Examples of people management objects may include learning, skills, goals, reviews, feedback and user profile.

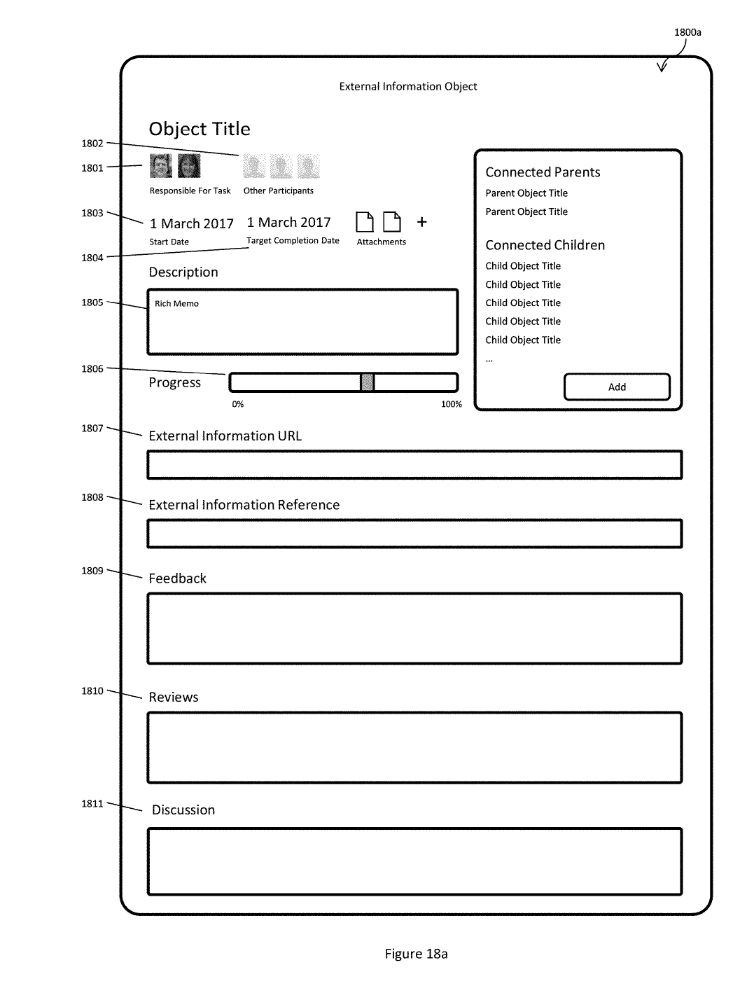

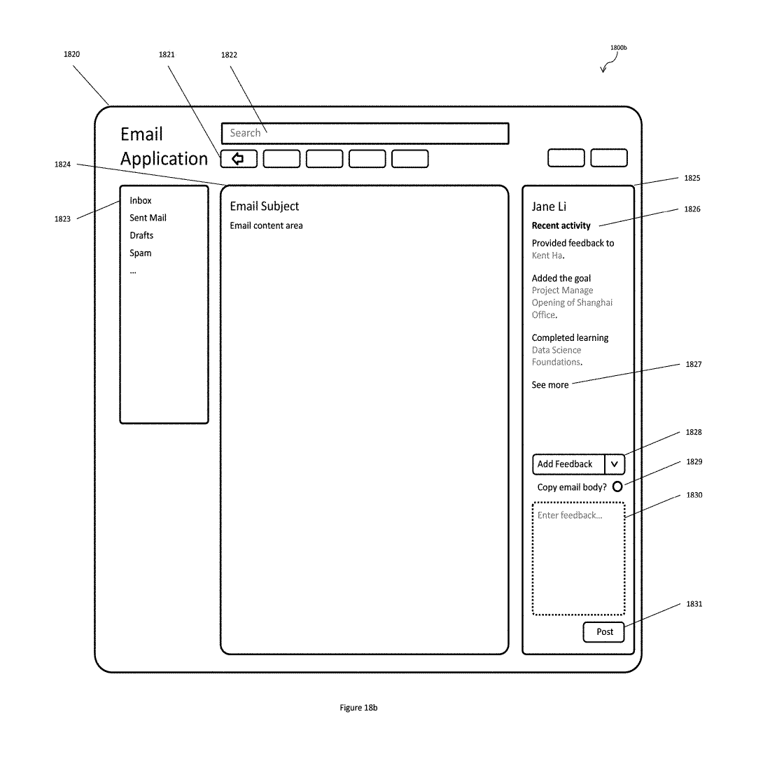

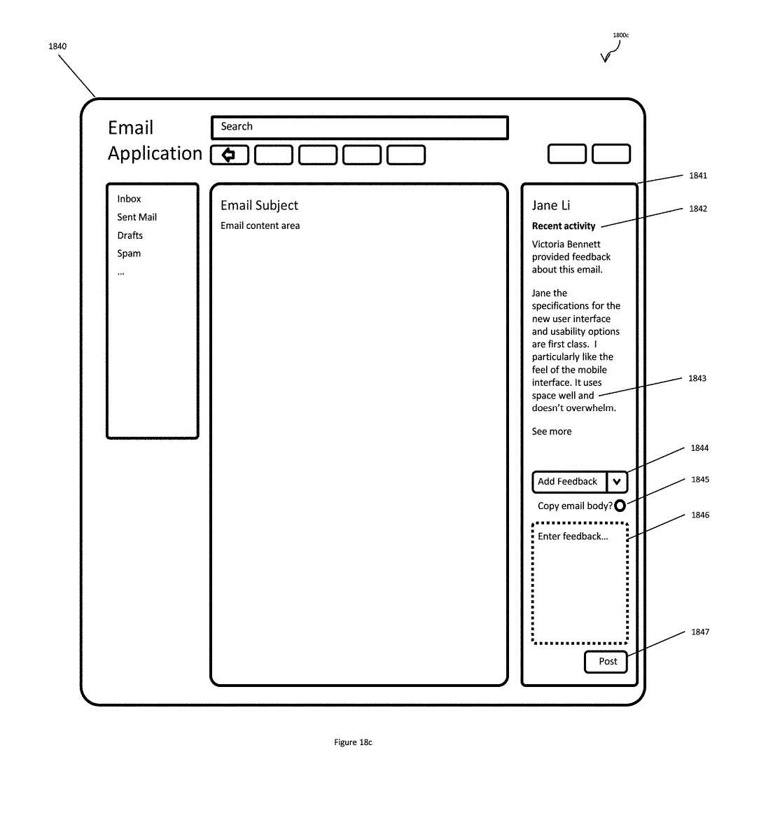

Each people management object contains one or more participants. The people who are participants in the people management object may be, for example, employees, contractors and the like. But it will be appreciated that in some people management objects such as a goal people management object the subject participants may be the people or a person responsible for people in achieving that particular goal for example, the head of a team or a manager or the like. In contrast for a people management object relating to a review, the participants would be the person being reviewed and/or their supervisor for example. People management objects can be connected to other information and/or connected to other people management objects, work objects and external information objects. It will also be appreciated that external information objects may themselves provide information to a PMO (which will be discussed with reference to FIGS. 18a, 18b and 18c).

The ability to connect objects enables people management objects to be connected to work as it is occurring. It also allows for the ability to create greater meaning within the context of an action being carried out whether that be work, a task, a goal, learning, skills or review. This occurs in two ways, 1/1 linked people management objects which are connected to either other information or other people management objects can aggregate information or combine information between the people management objects or the other information or the people management objects themselves. For example, if there were a number of tasks carried out of a 6 month period an aggregated or combined number of people management objects might be all the tasks and reviews of those tasks over a 6 month period. The second aspect is that people management objects have at least one subject participant. This for example enables all of a person's learning objects to be accessible through their user profile.

It will also be appreciated that any people management object may be connected to any number of other people management objects, work objects or External Information Objects via an API.

It will be appreciated that work objects may include but are not limited to tasks, conversations, plans and the like. Work objects may share common elements and may also contain special purpose data. Common elements may include a title, a list of one or more participants, optional resources, a discussion and optional connections to any number of parent and child objects. Special purpose data might include for example, a start date and an end date for a task and the like.

With regard to External Information Objects via an API, the external information may be other systems where work is occurring and the API allows the people management object to be connected to External Information Objects thereby extending the capabilities of the present disclosure beyond its basic design. The API Mechanism enables developers to utilize parts of this disclosure with external systems. This includes both collections and mechanisms.

API calls may include for example:

Create Object, Set URL to External Information Object, Get URL for External Information Object, Create Object connection, Retrieve all child connections, Retrieve all parent connections, Get goal, Get review, Get agile feedback, Get learning, Get skill, Get task, Get conversation, Get plan, Create goal, Create review, Create agile feedback, Create learning, Create skill, Create task, Create conversation, Create plan, Get title, Get subject participants, Get dates, Get attachments, Get other participants, Get special purpose fields, Set title, Set subject participants, Set dates, Set attachments, Set other participants, Set special purpose fields, Get Learning suggestions, Get Aggregate Review Ratings, Skill Learning Assessment and Skill Assessment.

People Management Objects collect management information for one or more individuals in the system. There may be different types of people management objects depending on the people management function (such as skill, learning, goal, review and feedback) In the description there are a number of names and different types but it will be appreciated that the concept is not limited to those types. Irrespective of the people management object whether that be relating to a task, a review, learning and the like, all people management objects contain common elements irrespective of type which include: one or more subject participants which are people who are the subject of the people management information. For example in the case of a learning object this would be the person undertaking the learning and for a skill object this would be the person deemed to have the skill in order to carry out the task for example. Subject participants in a review object would be the people who are being reviewed, assessed or receiving feedback.

Another common element is participants may have different roles. For example, in review objects unless a subject participant is undertaking a self-assessment at least one other participant is needed who plays the role of reviewer and in addition another reviewer may be a representative of Human Resources and/or the subject participants manager. Other common elements include optional resources which can be attached as files or links or other resources such as online documents and websites. Also conversations may be provided which allows a participant to discuss the content of the object. Also provided is the ability to connect to one or more parent or child objects. These may be other people management objects or work objects. For example a learning object in a child relationship might be connected to a parent skill object as evidence for that skill. In another example a review object may be in a child relationship connected to a parent task object to enable an assessment of the work undertaken.

In addition optionally connections to external information may be provided by an API and as well as special purpose management information.

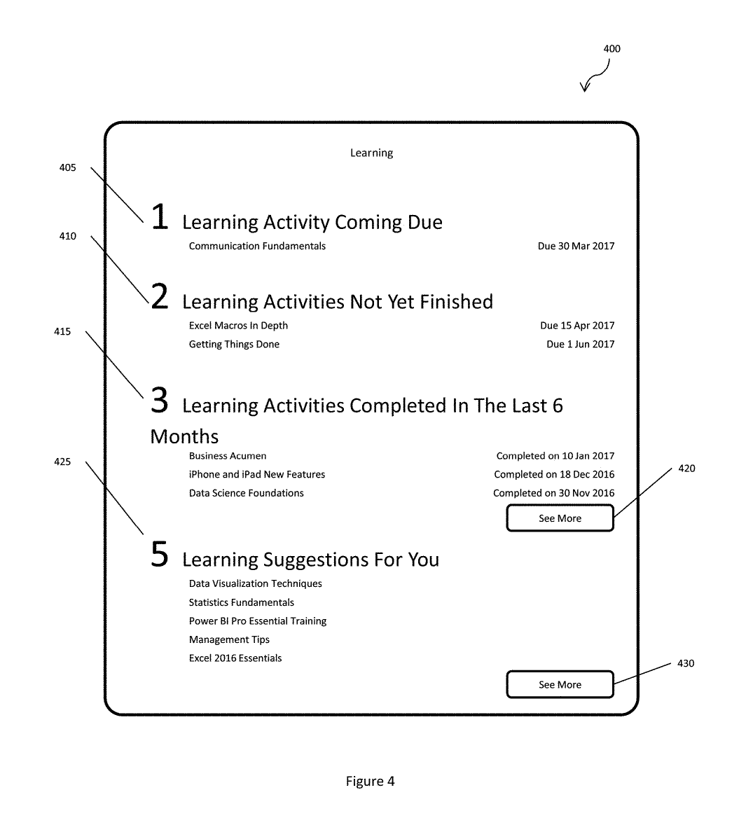

In FIG. 3, user interface 300 illustrates an example user interface for a user profile. There is provided a number of fields including a profile header image 105 where the user can upload and modify their user profile. A name field 105 is provided, a contact information field may be provided which includes phone, email, social contacts and LinkedIn™ ID together with a hyperlink to a LinkedIn profile for example, education and qualification field which contains qualifications that a person has been awarded, the institutions that awarded the qualifications and the date range in which the qualifications occurred. A licenses and certifications field 130 describes the licenses that a person holds, major capabilities in which the person is certified, the institutions that awarded them and the date range in which they are valid and when a person needs to be recertified. Further fields include an interest field 135 in which a person can describe hobbies and other pursuits they are doing or would like to do. Profile image fields 140 may be provided where the user can upload pictures to further personalize their user profile. Importantly the user profile is automatically connected to one or more people management objects 145. Connecting to multiple people management objects allows information to be presented in a meaningful way. As a result, for example skill objects and learning objects in which the person is a subject participant will automatically be connected as child objects to the user profile. Advantageously this enables all of a person's people management information to be accessible though their user profile. Given the volume of data which may be collected a filter is provided to enable a user to derive value and meaning from the information. The filter may be displayed in the people management object field 145 which displays people management information in a more meaningful way and allows the user to explore any part they wish further. A series of tabs through which the user can choose the types of people management information they wish to view as shown in FIGS. 4, 5, 6 and 7.

FIG. 4 is a user interface illustrating a tab which may be provided in the people management object field 145 of FIG. 1 illustrating learning information. Displayed to the user is an aggregate of learning objects in which a person is the subject participant. Advantageously this is provided without the need for any user to connect to learning objects since they are automatically connected in a child relationship by virtue of them having the same participants. A learning activity coming due field 405 is provided which summarizes any learning objects in which the due date of the object is occurring within a particular time period. The time period may be 10% to the total duration of the learning object for example. The total duration of the learning object may be determined as the due date minus the start date in an alternative. For each of the matching learning objects presented, the learning activities coming due 405 displays the object title and the due date. The user can click or tap on the title to open the learning objects.

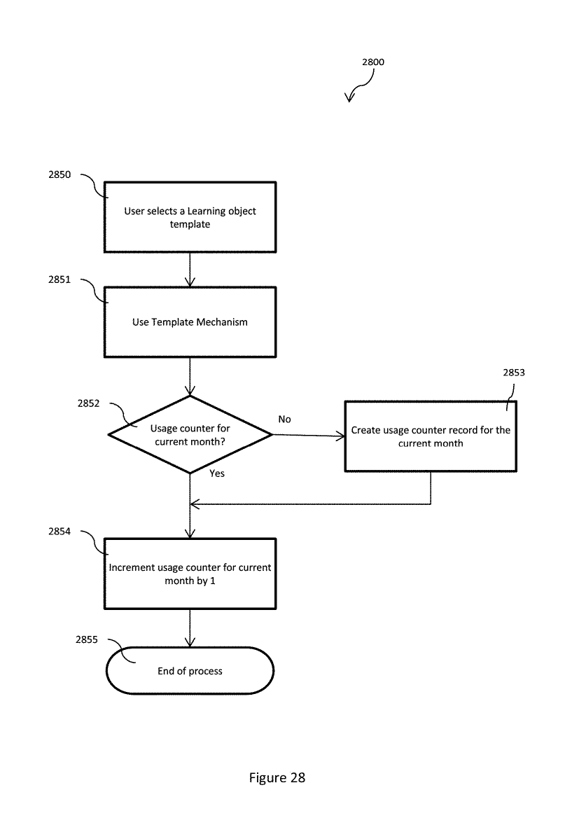

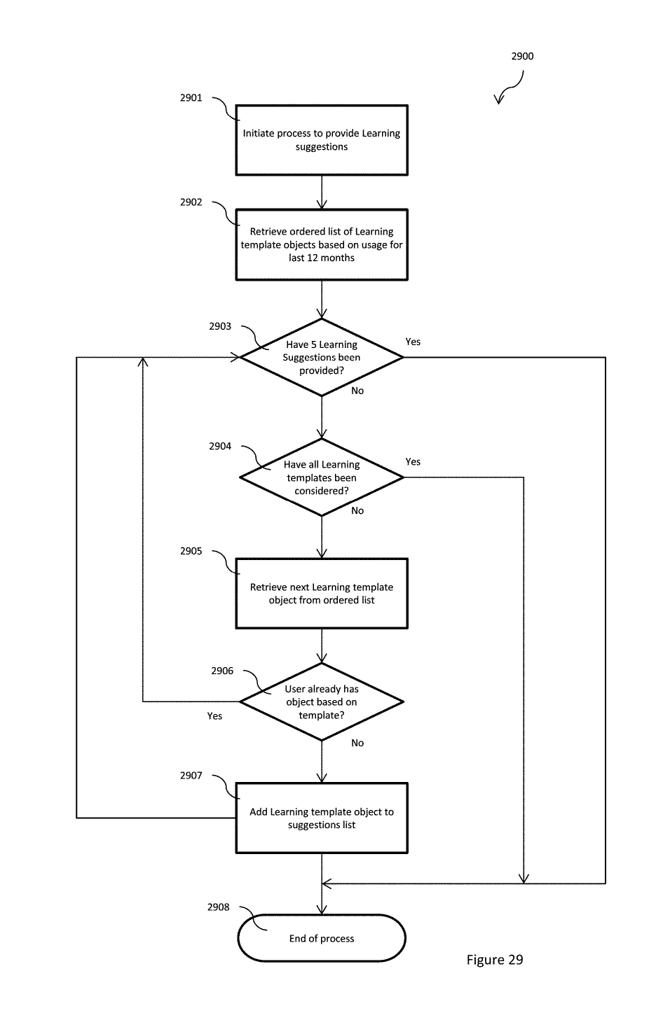

Field 410 is learning activities not yet finished which summarizes learning objects that have not been marked as completed. For each learning object not complete the object title and due date may be displayed. Again, the user may tape or click on the title of the object to open the learning object. Field 415 is learning activities completed within the last 6 months which shows all learning objects for the participant that were completed within a date range which may be 6 months for example. A button 420 may be provided in which the user can see the next 6 months of completed learning objects. The title of each learning object and date it was completed may be displayed and again the user can click or tap on the object title to open the learning object. Field 425 is learning suggestions for you which displays a list of suggested template learning objects that the learning participant may consider. The user may click or tap on the template object title to open the learning object and then optionally add it to their user profile for their own use. In addition the learning suggestions for you field 425 contains a suggestion list for “popular” learning objects. This section lists learning objects that the participant does not have connected to their user profile already and which have been most commonly used by other users over the last 6 months. This will be described further with reference to FIGS. 28 and 29. Again a see more button 430 is provided which will provide more suggested learning objects.

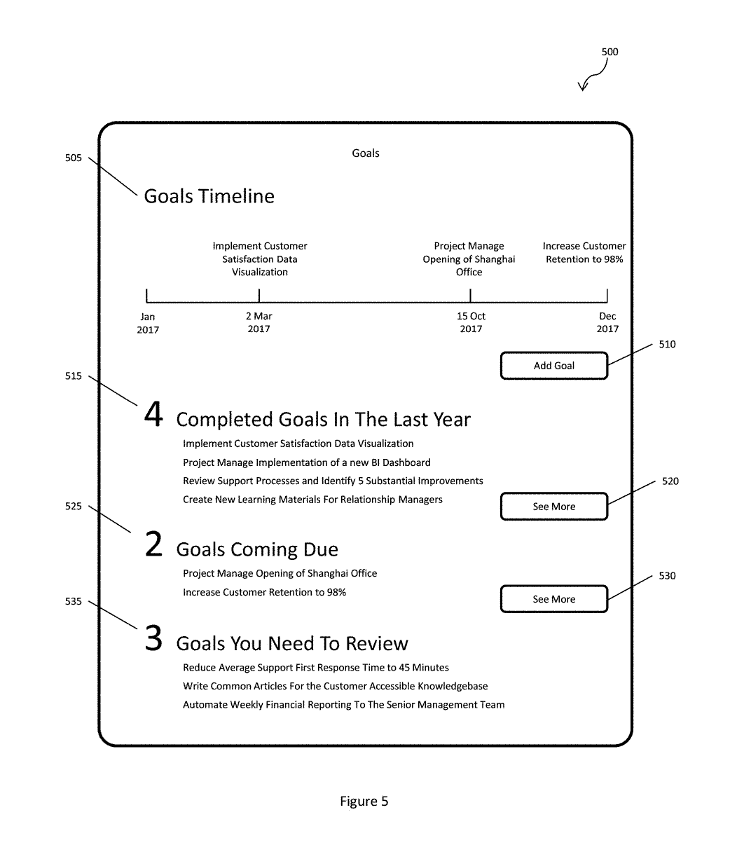

FIG. 5 is an example user interface illustrating a tab which may appear in field 145 of FIG. 3 namely a goals tab 500. This provides an intelligent filter that aggregates goal objects in which a person is a participant. Advantageously this is provided without the need for a user to connect goal objects to the user profile of a user, they are automatically connected in a child relationship by virtue of having the same participant. A goals timeline 505 may be provided which may be based on the current calendar year and shows goal objects in which the participant is involved in. The goal objects may be positioned on the timeline according to their target completion date and add goal button 510 is provided to allow the user to create a new goal which will then be automatically connected to the user profile. Also provided is a field 515 which is completed goals within the last year that list goal objects in which the participant has completed within the last 12 months. The title is displayed for each goal object and the user may click or tap on the title to open the goal object. A see more button 520 may be pressed by the user to see goal objects that were completed more than 12 months ago and each time the button 520 is clicked an additional 12 months of completed goal object is displayed.

A goals coming due field 525 may be provided which lists goal objects in which the participant is involved in and which have a target date that is between the present date and 3 months from the present date (it will be appreciated that this may be varied). Again the title is displayed for each goal object and the user can tap or click on the title to open the goal object for more details.

A see more button 530 is also provided so the user may see more than 3 months beyond the present date, for example, 6 months beyond the present date and with each click adding an additional 3 months beyond the present date.

Finally, a ‘goals you need to review’ field 535 is provided which lists goal objects in which the participant is involved or where they are the reviewer and where the review has not already been completed. Again, the title is displayed for each goal object and the user can click or tap on the title to open the goal object and complete the review.

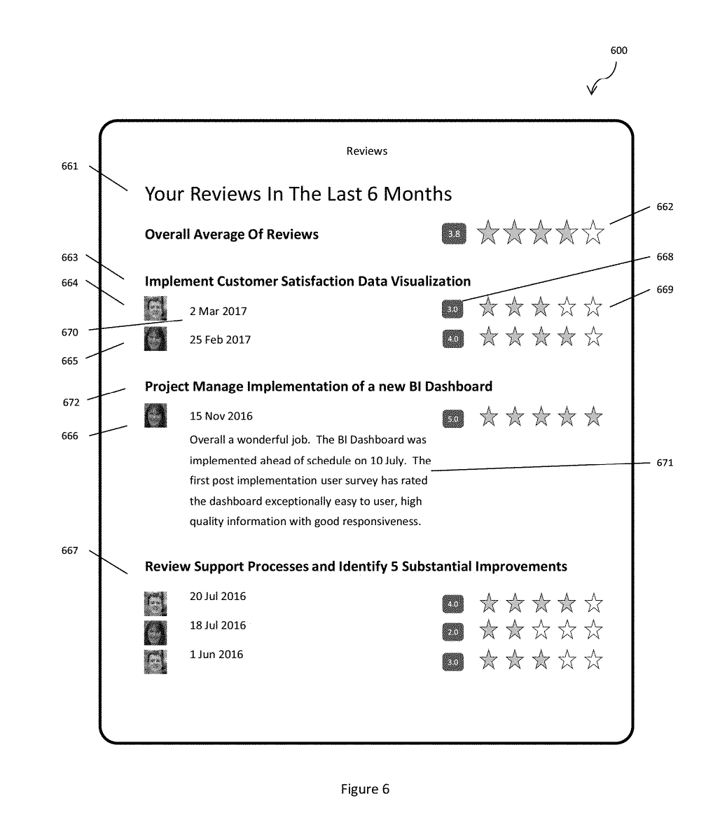

FIG. 6 is a user interface 600 of an embodiment of the present disclosure in which a tab may be displayed in the people management object field 145 for FIG. 3. The user interface 600 is an intelligent filter that aggregates review objects in which a person is the subject of the review. Advantageously this can be done without the need for a user to connect the review object to the user profile of the relevant person since they are automatically connected in a child relationship by virtue of having the same participant.

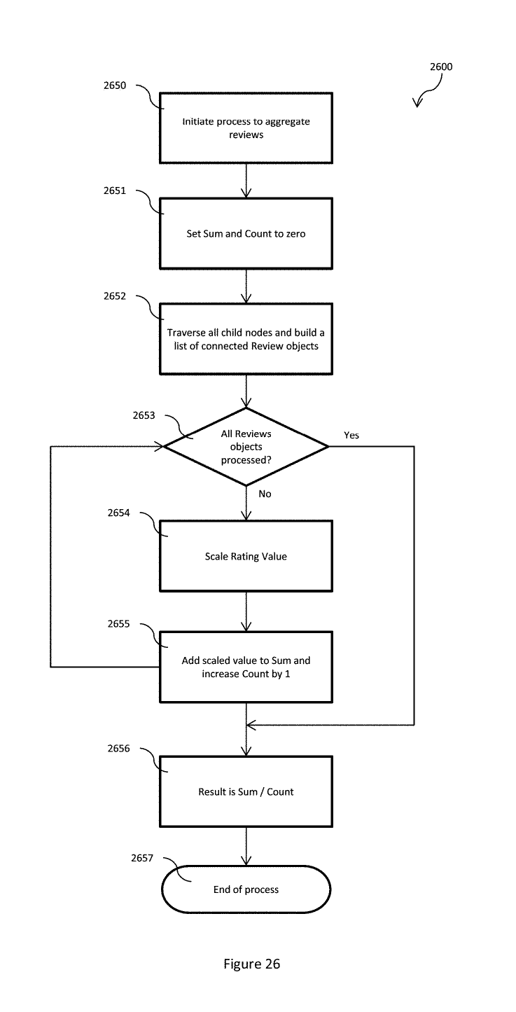

A field 605 is provided for reviews in the last 6 months which shows aggregates and more detailed information about the review object in which the participant is involved and that it was completed within the last 6 months further includes an overall average of reviews which provides an aggregate of all review object ratings for the period shown which may be displayed using a numerical scale, a worded scale or where the graphical illustration such as the stars 610. It will be appreciated that the overall average is capable of aggregating reviews with different scales and the mechanism for this will be detailed with reference to FIG. 26.

For each review object the title of the object to which it is connected as a child is displayed. For example, 663 and 667 in which are both goal objects. Under the title, each individual review is displayed. For each review, a picture of the reviewer 664, 665 and 666 may be shown. The date of the review 670 is displayed along with the rating 668 and the visualization 669, if a review includes other commentary such as free-text 671 that may also be displayed. For example, as shown in FIG. 6 the “implement customer satisfaction data visualization” shown as 663 subheading, is the title of the object, in this case it is a goal object to which the review object was connected as a child. Under this title, the reviews are displayed in order of the most recent first. The review 664 includes a picture of the reviewer 664, the date of the review 670, the rating chosen by the reviewer 668 and a visual representation of that rating 669. A second review 665 for the “implement customer satisfaction data visualization goal” is also shown. As can be seen, this review was completed by a different reviewer on a different date.

A further example is shown as project management implementation of new BI-board denoted 672 which is another goal object. In this case only one review 666 has been completed for this particular goal. The review also included free-text commentary 671 in addition to the ratings.

Finally, the goal object titled “review support processes and identify substantial improvements” denoted as 667 is a further illustration of the capabilities. It demonstrates two reviews completed by one reviewer on different dates and a third review completed by a different reviewer.

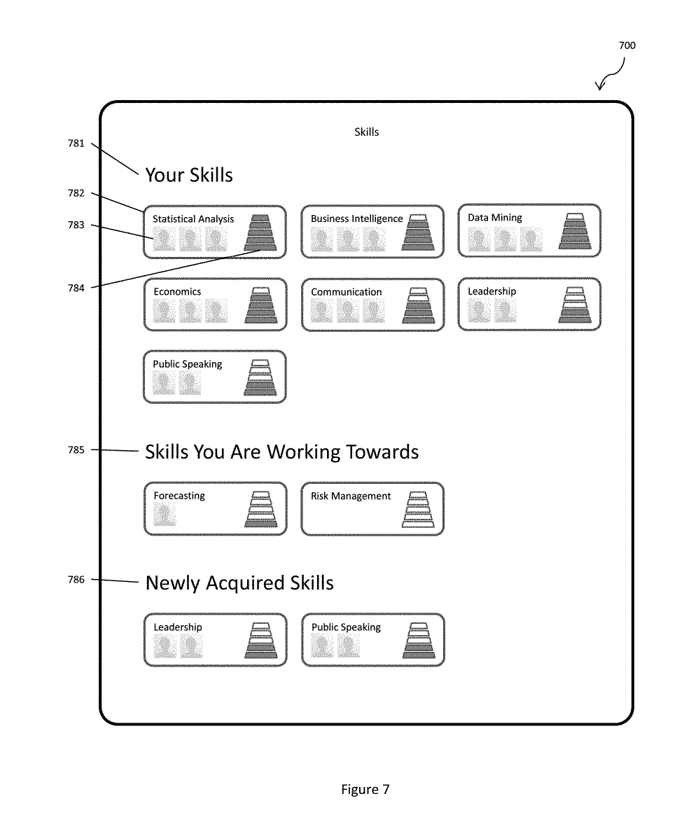

FIG. 7 illustrates the skill section within the people management object 145 of FIG. 1. This user interface 700 is an intelligent filter that aggregates skill objects and their connected review objects for a participant. This is done without the need for a user to connect the skill object to the user profile of the relevant person since they are automatically connected in a child relationship by virtue of having the same participants. The “your skills” section 781 shows a sorted list of skills against which a person has been reviewed. For each skill object such as statistical analysis 782 a connected review object in which the person is the subject of the user profile is also the subject of the review are aggregated. The mechanism for this aggregation will be described further with reference to FIG. 26.

A picture 783 may be shown for each reviewer in the connected review objects. A visual representation 784 of the aggregate of the review object ratings indicates the strength of the skill. Clicking or tapping on the skill 782 will open the skill object to enable further exploration of the connected review object or discussion of the skill.

Skills are you working towards 785 shows a sorted list of skill objects against which a person has started to be reviewed but for which a minimum required rating has not yet been reached.

Newly acquired skills 786 is a sorted list of skill objects in which the profile participant has recently been reviewed and for which the review ratings are at least the minimum required for recognition as having the skill. Recently it has been defined as being within the last 3 months but it would be appreciated that this may be modified.

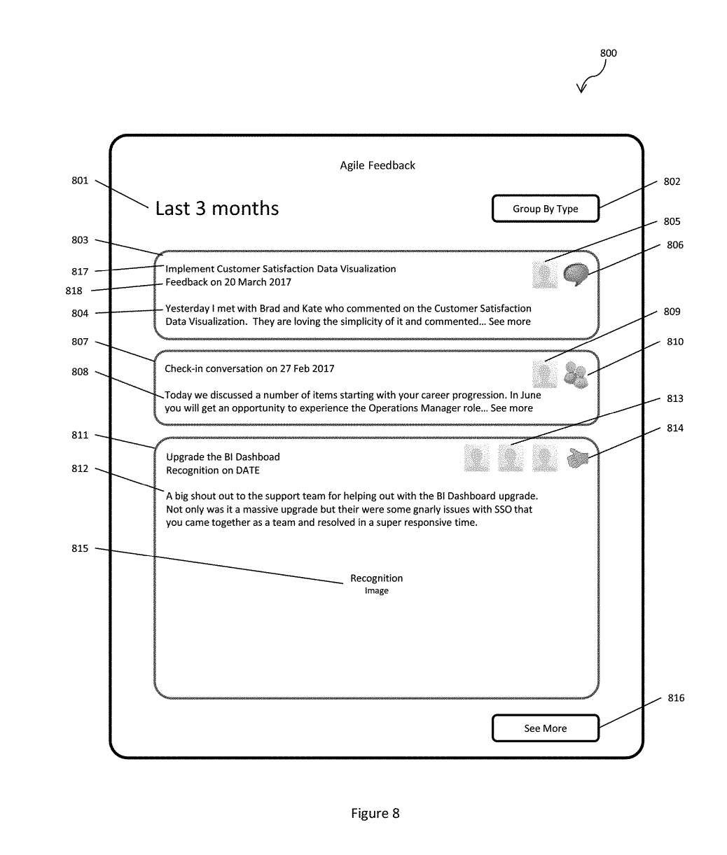

FIG. 8 is an example user interface 800 of a feedback section within the people management object 145 of FIG. 1. This section is an intelligent filter that aggregates feedback objects for a participant. This is done without the need for any user to connect the feedback object to the user profile since they are automatically connected by way of a child relationship by virtue of having the same participants. The last 3 months section 801 shows a list of feedback the participant has received through feedback objects. The group by type button 802 may be used to collate the feedback objects into the type of feedback received. For example, feedback, check in conversations and recognition.

For each feedback object shown in 803, 807, 811, the feedback type is displayed along with the date that the feedback was received. Feedback entry 803 is of type “feedback” 818. If the feedback has been connected to a parent object, the parent objects title 817 is displayed. By clicking on this title it will open up the parent object—the parent object is this case would be, for example, the task.

The content of the feedback 804, 808, 812 and 815 may be displayed in rich text, picture or video format A picture of a person providing the feedback 805, 809 may be displayed alongside any other people it is shared with 813. An icon 806, 810, 814 may provide visual representation of the type of feedback, for example. The see more button 816 may be clicked and display the next 3 months of feedback objects.

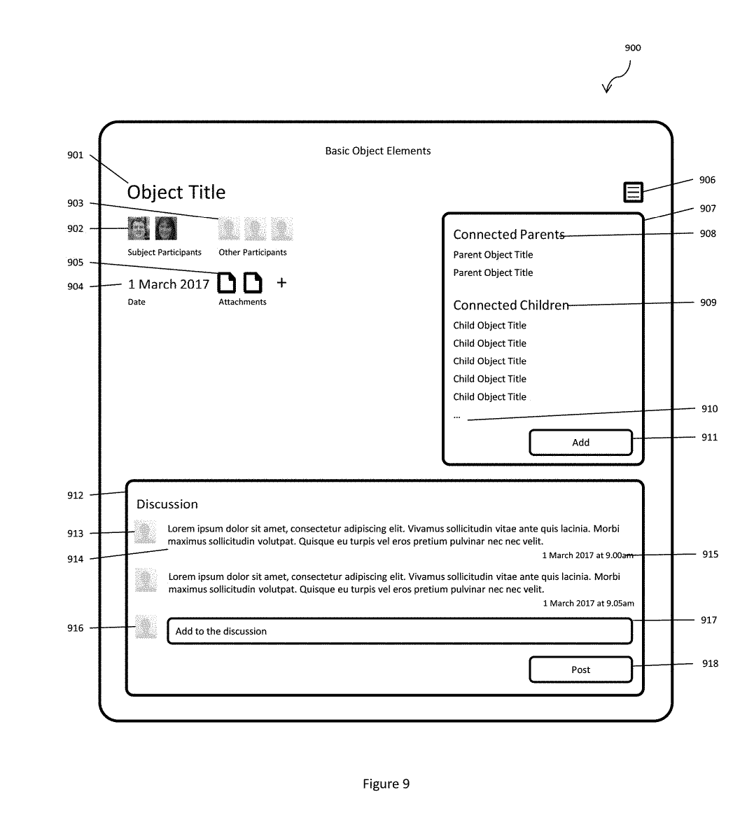

FIG. 9 is an example user interface 900 illustrating common object elements shared by people management objects in addition to common elements each type of people management object contains additional special purpose information. The special purpose information is described for each type of people management object type described above.

Each object has an object title 901 that a user can edit. Objects can have subject participants 902 who are the responsible people for the object. In a learning object, the subject participants are the people or person undertaking the learning. However in a goal object a subject participant are the people responsible for achieving the goal.

In addition to the subject participants objects can have other participants 903. For example these are the people who aren't responsible for the object but may have some interest in it. For example, in a goal object, an employee's manager might be another participant. This would enable the manager to track the progress of the goal and discuss it with the participant (e.g. the employee). Objects may have a date 904 and depending on the type of object the date may have different uses. For example in a goal object the date is a target date for completion of the goal.

Also provided is an attachments section 905 which contains one or more files, links to websites and other online resources. Attachments may be accessible to the subject and other participants.

Objects may also have a menu 906 which can be used to delete the object or modify security permissions to determine what participants can do with the object.

Importantly objects have the ability to connect to other objects and “objects section” 907 list those connections. Connections between objects enable greater meaning to be formed within the overall system. For example, goals can be part of larger plans and reviews and can be aggregated across a number of goals. The connected parent section 908 lists any objects that the object 901 is connected to. In these objects, the object 901 may be a child or subordinate of the parent object 908. The object 901 forms part of the connected parent object 908.

The connected children's section 909 lists any objects that are connected to the object 901. In these connections, the object 901 is a parent of the child object 909. The child object 909 may form part of the object 901. There is provided an ellipsis symbol 910 which indicates that there are more child objects. Clicking the ellipsis will list additional child objects for display. There may be provided a discussion section 912 which may be used by the participant 902 and 903 to communicate about the object. Where a participant posts a comment in the discussion, their picture 913, the post content 914 and a date and time of the entry 915 are provided. The current user, as indicated by picture 916 may post a new comment in the discussion but entering their comment 917 and clicking post 918.

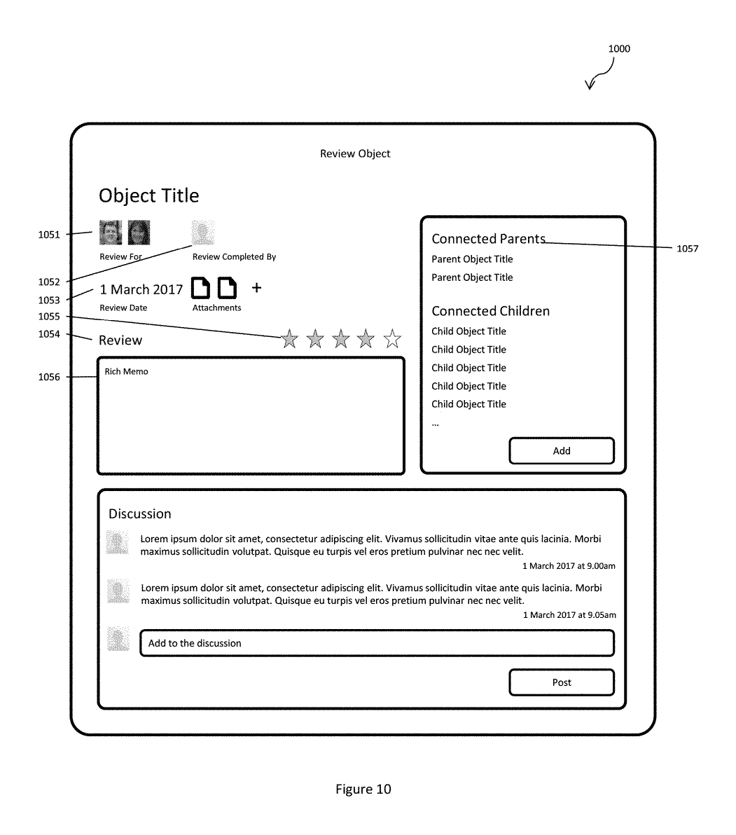

FIG. 10 is an example user interface 1000 of the interface for a review object which includes additional elements to those described in FIG. 9. In a review object the subject participants are titled in the “review for” section 1051 which is the person or people for whom the review relates. The connected parents section 1057 is the object or group of objects in which activities have occurred that are being reviewed.

The other participants in a review object are provided in the “review completed by” section 1052. This is the people or person who has conducted the review. A review date 1053 may be provided which indicates the date of the review. The review section 1054 is comprised of a rating 1055 and a rich text memo 1056. For example the rating 1055 may be a five star visualization but it will be appreciated that the format of the rating may be of any type and a range of possible scales such as numeric, word, graphical or no rating at all may be provided. The rich text memo 1056 may house the descriptive portion of the review to be complete and may include text, images and video embedding and the like. It will be appreciated that a number of object types may support a review. In the case of a goal object this means that the review may be completed from within the goal object itself without having to open up and view the review objects. When a review is completed, the rich text memo 1056 and rating 1055 are visible and can be edited within the parent object. Other content including date and participants are automatically completed by the review addition mechanism.

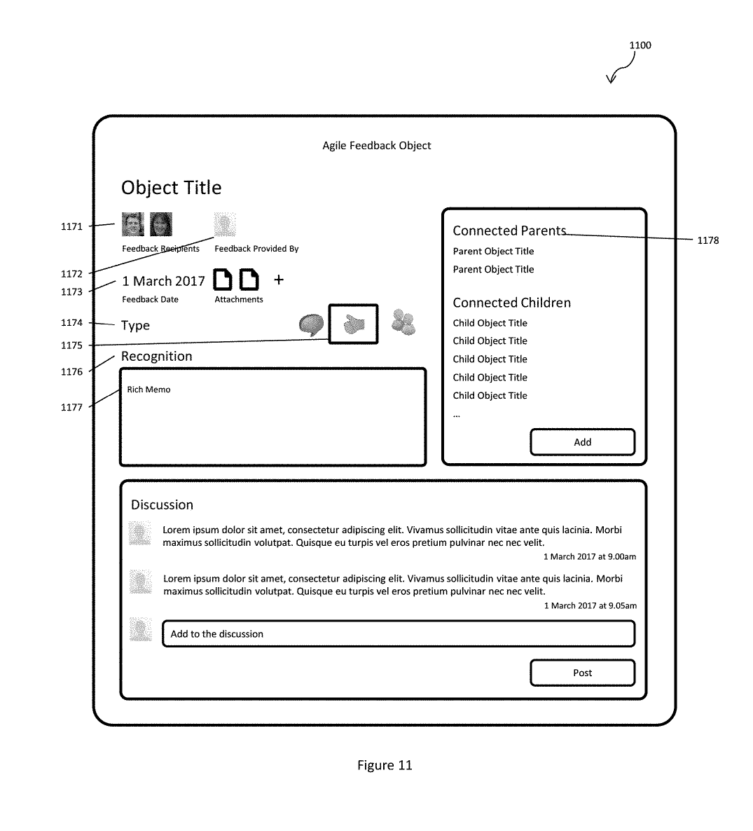

FIG. 11 is an example user interface 1100 of an object for feedback where, for example, one piece of feedback may come from multiple people and may be applied to multiple people at the same time, which we may denote “agile” feedback. The elements in user interface 1100 are in addition to those described with reference to FIG. 9.

In a feedback object the subject participants 1171 are title “feedback recipients”. This is the person or people for whom the feedback is being provided and the other participants 1172 are entitled to “feedback provided by” which is the person or people who are actually providing the feedback. Feedback date field 1173 may be provided which indicates the date that the feedback was provided. Type field 1074 allows the user to choose whether they are providing feedback, recognition or a record of a one on one conversation or informal review for example. In the present example the user has chosen recognition 1175 and the recognition 1176 is then provided using a rich text memo field 1177 which may support formatted text images and embedded video and the like. A number of object types support in-place feedback. Where, a user, without leaving a particular PMO can click a button to add feedback. This avoids the need to access a feedback PMO, accessing that feedback PMO and entering the feedback, then going back to current PMO (a task PMO for example) to see it also in the task.

In the case of a task object this means that the feedback can be completed from within the task object itself without having to open up and view the full feedback object. When an in place review is completed, the type 1174 and rich text memo field 1177 are visible and can be edited within the parent object. The other content including date and participants are automatically completed by the feedback addition mechanism.

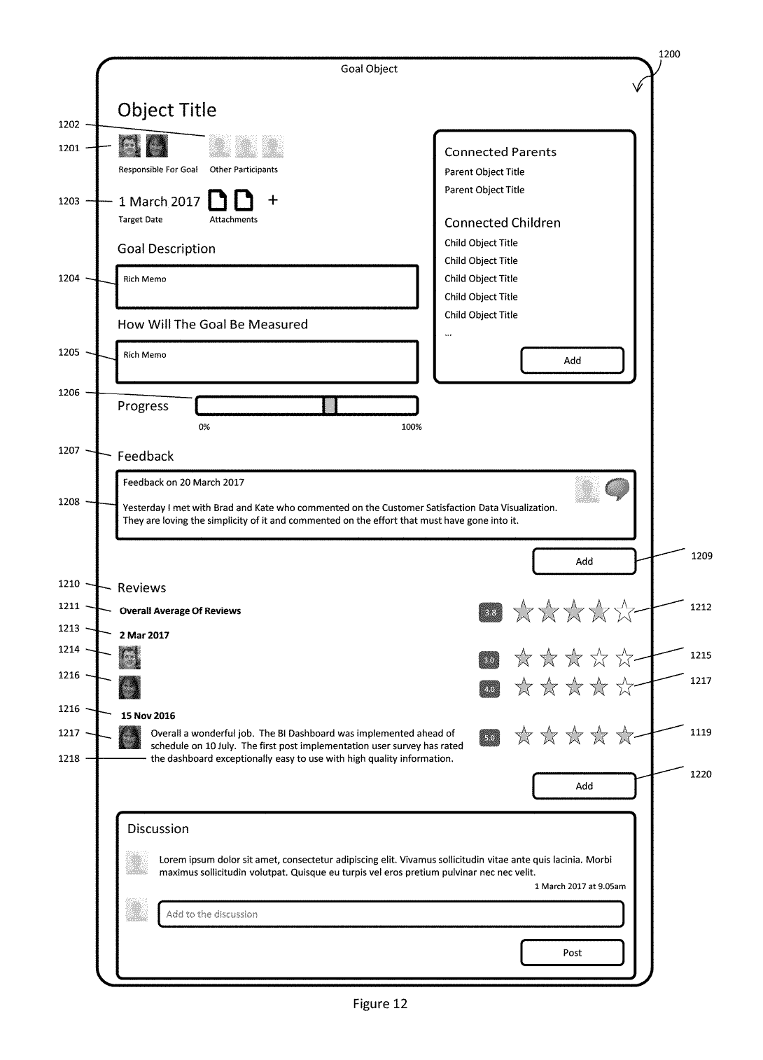

FIG. 12 is an example user interface 1200 illustrating a goal object. The goal object includes elements previously described in FIG. 10. In addition a goal object includes additional features such as one or more participants 1201 titled “responsible for goal” and any number of other participants 1202 to also have access to a goal object. A target date 1203 may be provided to identify when a goal should be completed for example. In a goal object, the title may be used to specify the goal itself. The goal description 1204 enables a user to describe the goal in more detail and a further field 1205 may be used to state how the achievement of the goal will be measured or determined. A progress indicator 1206 may be used by participants to express the amount of work completed and the amount yet to be completed to achieve the goal. The feedback section 1207 may be used by all participants (either the person who is carrying out the goal or the person who has set the goal) to provide feedback and recognition. This is achieved by the add button 1209. Once the add button 1209 is enabled and a feedback object is then created and the user can enter their feedback in place. If the user wishes to they can click on a feedback entry form 1208 to open the feedback object. The reviews section 1210 may be used by participants (either the person who is carrying out the goal or the person who has set the goal) to review achievement for the goal. Any reviews for the goal are aggregated in the overall average of reviews (OAR) section 1211. The aggregate is expressed in the present example using a graphic visualization 1212 but it will be appreciated that the expression could be carried out in any number of ways. In the user interface of FIG. 12 reviews illustrated which are completed on 2 separate dates 1213 and 1216. The participants who completed these reviews may be identified by their picture 1214, 1216, 1217 and any rating given in the review is expressed numerically and with a graphical visualization 1215, 1217, 1219. Participants can also enter their comments in a rich text memo field 1218 as part of their review. The add button 1210 is used to create a new review and enter it in place.

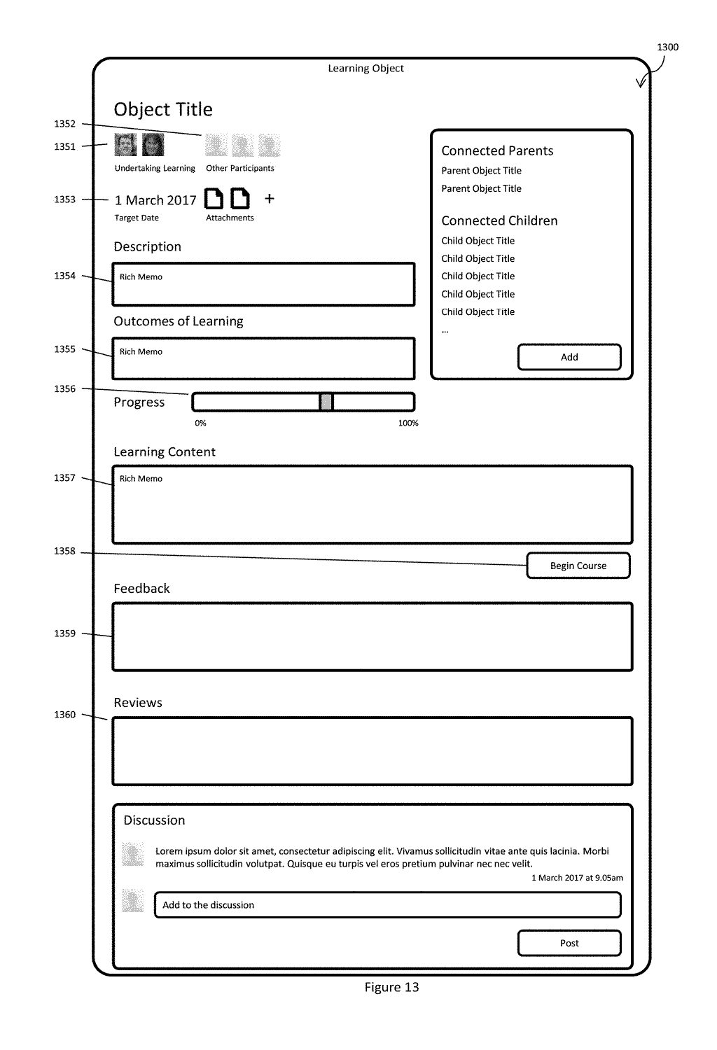

FIG. 13 is an example user interface 1300 which illustrates a learning object and particular additional elements to those already described with reference to FIG. 10.

Learning objects may include one or more subject participants 1351 entitled “undertaking learning” and any number of other participants 1352 can also have access to a learning object. A target date 1353 may be provided to identify when the learning goal should be completed. A description 1354 is provided to describe the learning object in more detail and defer the field 1355 is used to specify what the subject participant should know after completing the learning. A progress indicator 1356 is provided so that participants can express the amount of learning that has been completed and the amount yet to be completed.

Learning objects may contain both learning content 1357 and a button 1358 to access for example the learning courses that are for example SCORM, AICC or TinCan compliant. Learning content section 1357 may be a rich text memo field that supports formatted text, pictures and embedded video. Feedback section 1359 and review section 1360 perform the same function as that described for goal objects and in FIG. 12. In the case of a learning object they enable participants to provide feedback on the learning and more formally assess the outcome of the learning.

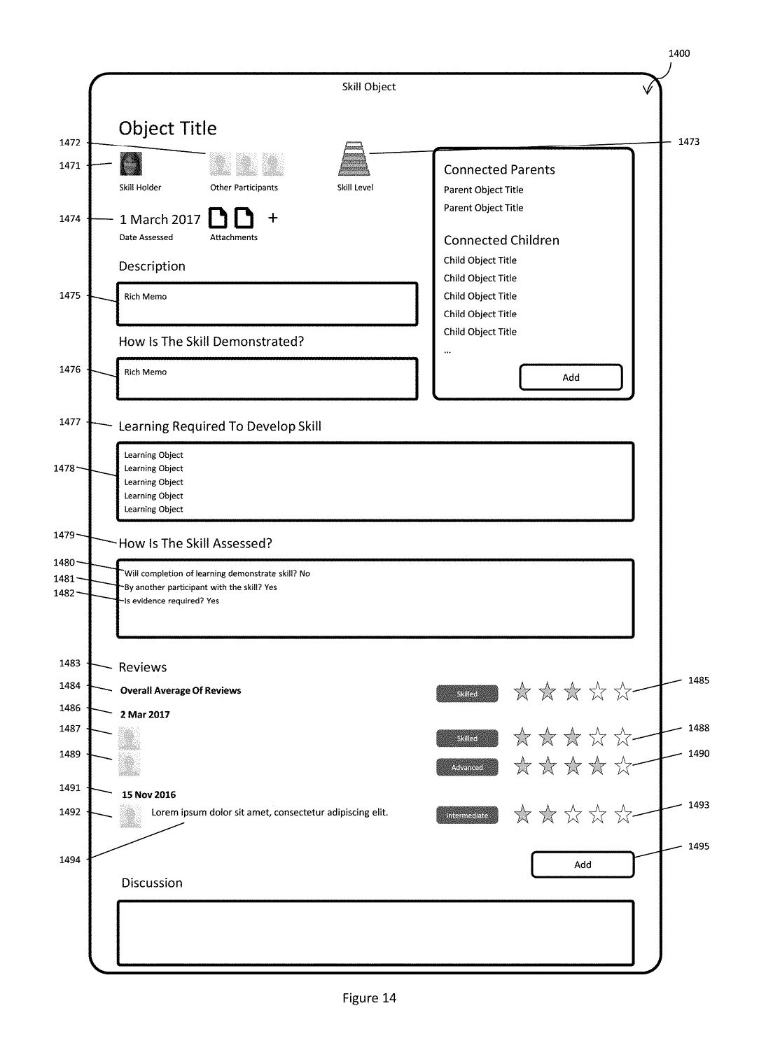

FIG. 14 is an example user interface 1400 illustrating a skill object and described below are additional elements which have not already been described in FIG. 10. In skill objects subject participants are title Skill Holders 1471 and any number of other participants 1472 may also have access to a skill object. The title of the object may be the name of the skill and a graphical indicator 1473 may be provided to provide a visual representation of the skill level. The indicator may be based on the same data as the overall average of reviews 1485. A date assessed field 1474 is provided which indicates when the last review of the skill was conducted. Like other objects, skills objects are based on a template and users can create skill objects that other users can use and be assessed against. Description field 1475 describes the skill in more detail and the content may be derived from the template skill object. Likewise a field for “how the skill is demonstrated” 1476 may be provided from the template. “How the skill is demonstrated” field 1476 describes how it is that you verify whether or not someone has the skill. A field “learning required to develop skill” 1477 is provided to contain a list of template learning objects 1478 that can be used by the participant. Clicking on one of the learning objects 1478 will open up the learning objects. The user can then make a copy of that learning object for their own use with the resulting object being automatically attached as a child connection. The content of the “learning required to develop skill” field 1477 is derived from the skill template object.

The “how the skill is assessed” field 1479 may be a list of standard questions with either a yes or no answer and the content for this section may be derived from a skill template object. For example, the questions included in this section may determine how the participants of the connected review 1483 can assess the skill levels. For example, if the answer to “will the completion of learning demonstrate skill” is a yes, a review object is not required to determine a skill level. The results of the learning object will be determined the skill level.

If the answer to “by another participant with the skill” is yes, then any participant in the skill object who is the subject participant of another skill object that is based on the same skill may conduct a review to assess the skill level.

The review field 1483 contains a list of any review objects that are connected as children to the skill object 1470. The “overall average of reviews” field 1484 may be a calculated aggregate of the connected review object. The resulting aggregate may be shown using a visual representation such as that shown in 1485. For example, in the present case two reviews have been conducted on 2 Mar. 2016 by participants denoted by 1487 and 1489. Their respective review ratings are shown as 1488 and 1490. Then on 15 Nov. 2016 a review denoted by 1491 was conducted by participant 1492 with the resulting rating a review comment being provided 1494. A button 1495 may be provided so to allow participants to create a new review object and connected as a child.

In FIG. 14 a skill template was created for a participant type of skill but it will be appreciated that templates can be created for any type of object. The purpose of templates is to create an object that other people can copy and utilize. For example, a template learning object may be created by a manager for his team members to learn a particular skill. In another example, an organization might create template skill objects so they can get a better picture of the skills within the organization.

It will be appreciated that the user may copy a template object for their own use and when they copy a template a new object is created with the contents of the template copied into it. The user is preferably added as the subject participant by default.

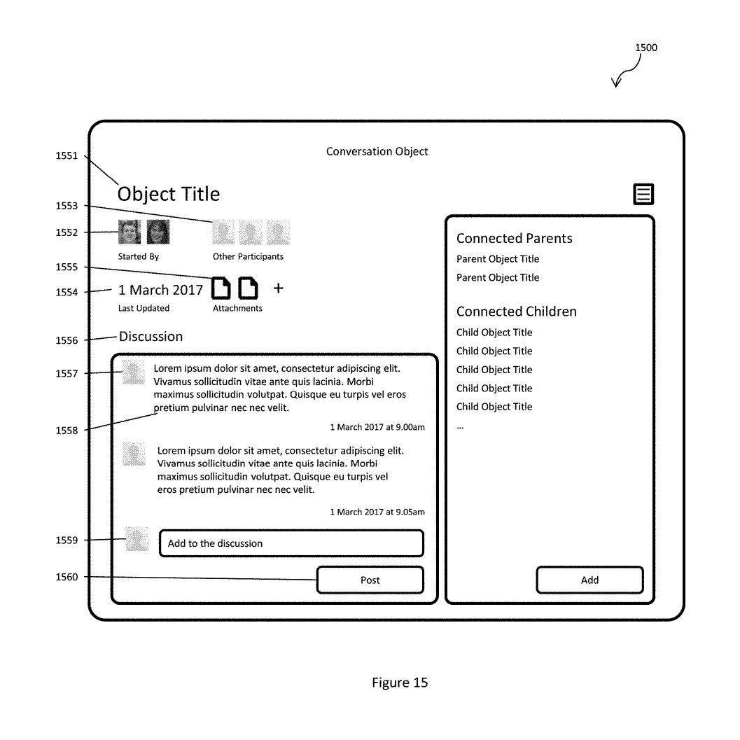

FIG. 15 is an example user interface 1500 illustrating a conversation object which contains the elements described with reference to FIG. 10 in addition to other elements which will be described below. In a conversation object, participants 1552 may be titled “started by” to indicate that they have originated the conversation or discussion but in addition any number of other participants denoted 1553 may also have access to a conversation object. A date 1554 is provided which indicates when the object was last updated. A discussion 1556 may occur through a series of posts and for each post a picture of a participant 1557 making the post may be displayed along with the content of the post 1558. A new post area 1559 may show the picture of the user participating along with an edit and the post may be added to discussion by clicking add button 1560.

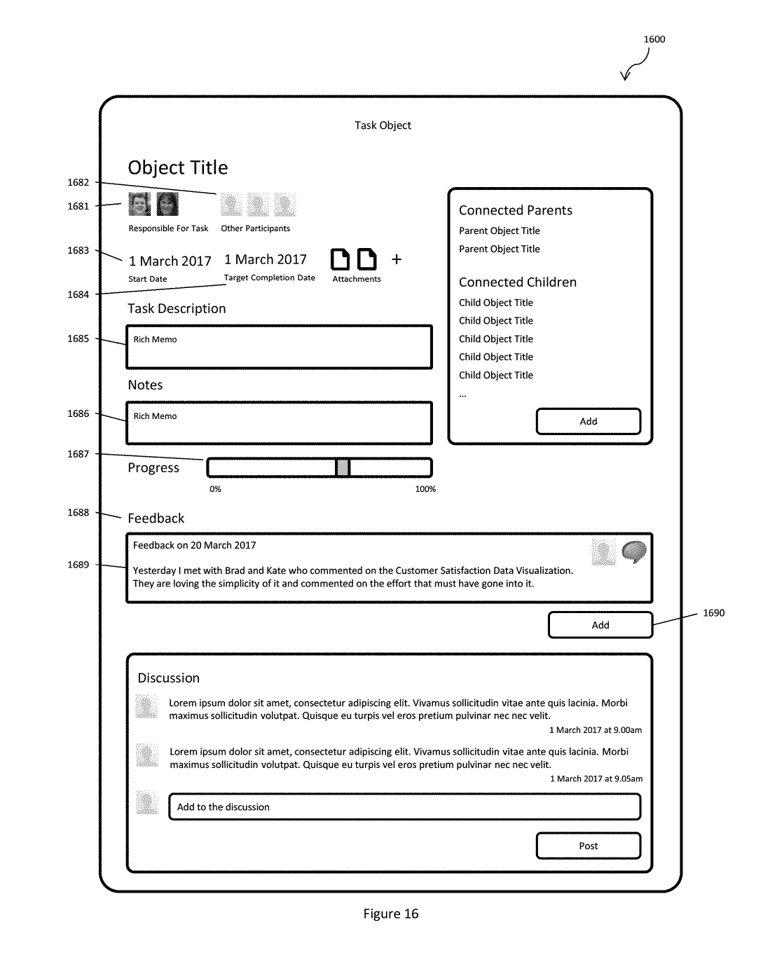

FIG. 16 is an example user interface 1600 illustrating a task object. The task object shares a common object element that is described with FIG. 10 but in addition the addition features related to a task object will be described below. In a task object subject participants denoted 1681 at title “responsible for task” and any number of other participants denoted 1682 may also have access to a task object. Task objects may be provided with a start date 1683 and end date 1684 to enable prioritization and reminders to be generated from the dates. Also provided is a rich text memo field 1685 which can contain pictures, text, video and the like. A notes field 1686 may be provided in a rich text memo format which can also contain text, pictures and embedded video.

A progress indicator 1687 may be utilized by the subject participants 1681 to express how much of the task has been completed to date and how much is yet to be completed.

Also provided is a feedback section 1688 which may be used by any of the participants 1681 and 1682 to give feedback to the subject participants 1681 (i.e. the people how are carrying out the task) feedback recognition for the tasks. For each feedback entry such as shown in 1689 the type of feedback, the data provided and the feedback content is shown along with a picture of the participant who entered the feedback. The add button 1690 is used to enter additional feedback.

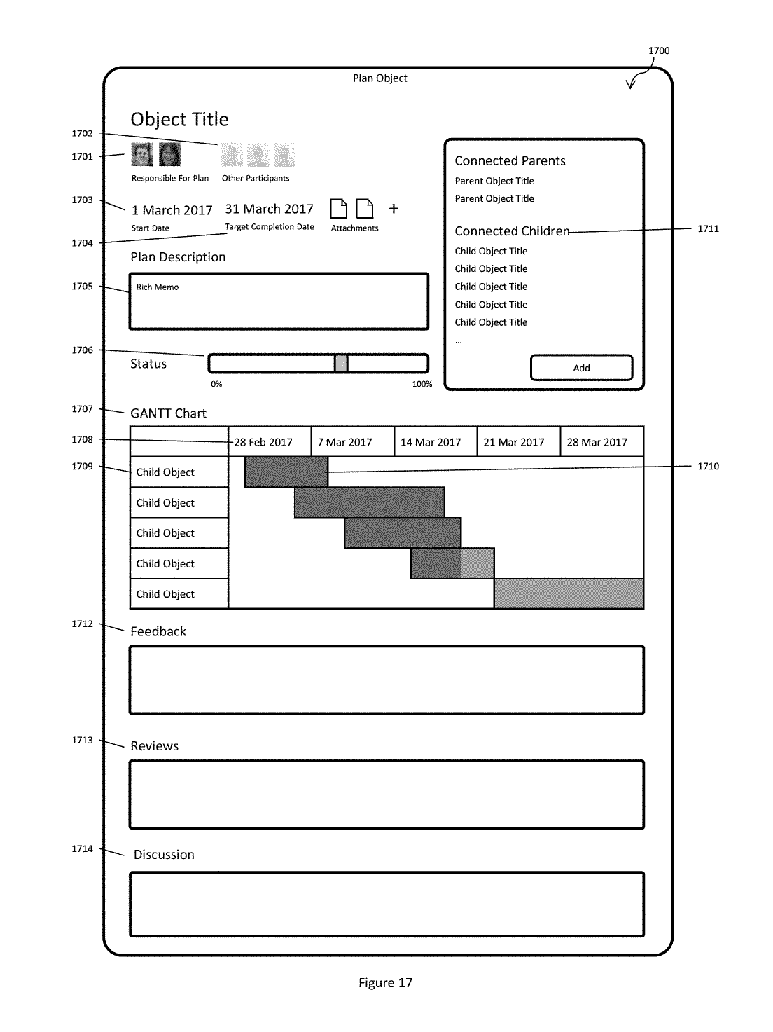

FIG. 17 is an example user interface 1700 illustrating a plan object. The plan object contains the common object elements described with reference to FIG. 10 but also includes additional elements which will be described below.

In a plan object the subject participants 1701 are titled “responsible for plan” and any other number of participants 1702 may also have access to a plan object. Plans include a start date 1703 and a target completion date 1704 so as to generate reminders and the like. A plan description 1705 may be provided as a rich text memo field that can contains formatted text, pictures and embedded video. The status 1706 may be provided which is a calculated indicator of progress for the plan based on the status of connected child objects. Some of these objects may include tasks goals and the like.

Also provided is a Gantt chart 1707 which provides visual representation of the progress of objects connected as children to the plan object. These may be tasks, goals, learning, other plans and any other type of object capable of recording progress. The date range 1703-1704 of the plan object is displayed along the header 1708 of the Gantt chart 1707. Each object connected as a child to the plan object 1711 that includes a progress indicator is displayed in the first column of the chart 1709. For each child object displayed, a visual indicator 1710 is shown to indicate when the object started, when the object ends and how much progress has been made, by clicking on a child object that will open that object. Also provided is a feedback section 1712, which is the same as that described for goal objects and a review section 1713 which the same as that for goal objects and a discussion section 1714 which is the same as that described above for other objects.

FIG. 18a is an example user interface 1800a illustrating an external information object. External information objects facilitate the use of components of the present disclosure as well as systems external to it. Developers can use external object to integrate any type of object and the respective mechanism with an external system.

For example if a company uses an in house task management system, by using external information objects the company's software developers may integrate the people management functionality of the present disclosure within the tasks and gain capability such as the aggregation provided within the user profile for example, according to the present disclosure.

In addition software developers can choose what parts of an external system should be formed into objects. In the example above, developers may choose to make each task in their task management system a separate external information object. For each external information object, the developers may then use an API to get and set information such as feedback and reviews. The feedback and reviews can then be aggregated on a user's profile.

When an external information object is created by a developer for example it is accessible like any other object as described with reference to FIGS. 1 to 17. External information objects share components with other objects including a title, subject participants 1801, other participants 1802, start dates 1803, end dates 1804, attachments, a description 1805, a progress indicator 1806 and connections to parent and child objects. External information URL 1807 provides a link if available to the external information. Likewise the external information reference 1808 may be used by developers to create any reference needed to identify the information in the external system. Feedback section 1809 reviews section 1810, discussion section 1811 performs the same function as that described with reference to the goal object described above.

FIG. 18a illustrates a user interface illustrating an external information object which facilitates use of components of the present disclosure as well as systems external to it. As shown in FIGS. 18b and 18c, email can be a tool which can be used in combination (and be integrated) with the system and method of the present disclosure. This allows the provide people management capabilities of the present disclosure to be used with email for example.

While a number of work systems are used in workplaces today (such as help desk systems, customer relationship management systems, task management systems and the like). The most common work system utilized today is email. Standalone software such as Microsoft Outlook is commonly used as are cloud based systems such as Google Gmail. Both of these email platforms support third party extensions or plug ins which makes it possible, for example in the context of the present disclosure to reference an individual email in an External Information Collection (EIC). Through the system and method of the present disclosure, the EIC then makes it possible to use additional capabilities from the present disclosure in order to provide people management capabilities which are linked to individual emails (as will be described with reference to FIGS. 18b and 18c).

FIG. 18b is an example user interface 1800b of an email application 1820. For example, consider an employee who is involved with an email exchange about a project. They may wish to provide feedback about that project and ensure that this feedback is visible to the employee's manager and considered as part of their next performance evaluation (for example).

Without the system and method of the present disclosure, the employee would need to access a human resources system that had feedback functionality, write their feedback and ensure that they include a context about either the email or the project so that it is clear what the feedback is about (for example, when the feedback is not being reviewed perhaps for 6 to 12 months).

In the present disclosure an individual can provide feedback from within their email application. Advantageously this is a natural place to provide the feedback because the work (or the communication about the work) is contained within the email.

For example, it is straightforward, at the end of a project if a good job has been done or if a good job has been done in the middle of a project (such as a small task within a project) to express gratitude or thanks in relation to that particular task or project. It advantageously provides an easy and immediate way to provide feedback rather than revisiting a project or the like months later and thinking about what feedback they could provide. In addition to the convenience of providing feedback when the work is actually occurring, the use of the EIC connected to the email advantageously provides context for the feedback.

The result of this is also that the next time the email is viewed by any person to whom the feedback collection is visible, the feedback will be displayed to them.

As noted above, emails themselves are also occasionally used by individuals to communicate feedback to another person. For example, an individual may thank another person for doing a good job, or perhaps even providing ideas on areas for improvement. Advantageously by referencing the email through an EIC it is therefore possible to create a feedback collection about the email itself where the content of the email becomes the feedback.

Advantageously, this provides for an easy way for an individual to record feedback and connect it to a profile which encourages giving feedback rather than the process of giving feedback being difficult (and therefore avoided) task.

In addition, email may be used to suggest learning activities and by referencing an email within an EIC, it is then possible to create, for example a learning object (such as that described with reference to FIG. 13) from that email where the content of the email becomes the initial content of the learning object.

In addition emails about tasks often suggest for the need for learning to be carried out in order to be able to complete the task and by referencing an email within an EIC it is then possible to connect a new learning object to the task or to the email.

As will be appreciated, any number of examples may exist but the context of an email, as shown in FIGS. 18b and 18c, feedback learning and the like can be provided.

FIG. 18b is an example user interface 1800b of an email application 1820. The functionality within the email application takes the usual form including buttons for navigating through email messages 1821, the ability to search through email 1822, folders for organizing emails 1823 and individual email messages 1824.

Email client management software (such as Microsoft Outlook, Google Gmail and the like) include plug in capabilities which typically enable a panel to be included within the user interface 1825. The work attached people management according to the system and method of the present disclosure occurs within that panel 1825.

For example, as shown in the user interface 1825, the email is not referenced by an EIC and as a result the recent activity section 1826 provides a summary of recent collections for user “Jane Li” who is in this example is the centre of the email.

Importantly, the user of the email software sees only recent collections that they are permitted to view. A user can access the collections shown within the recent activity section 1826 by clicking or tapping on those collections which will then open the collections within the system and method of the present disclosure. Likewise, clicking or tapping on the “see more” option 1827 will open user “Jane Li's” profile within the system and method of the present disclosure.

Dropdown button 1828 allows the email software user to create feedback, learning, goals or any other type of collection as previously described with reference to the disclosure and connected effectively to the email. In the event the user ticks 1829 this will cause the content of the email body to be copied into the content of the collection being created (be it feedback collection, goal collection, learning collection and the like).

Box 1830 allows the user to add written content to be included into the collection (for example specific feedback and the like) when the user clicks or taps on the post button 1831 the system and method of the present disclosure will create an EIC and title using the email subject line (or any other suitable identifier). In operation, an External Information Reference (EIR) will be saved within the EIC which will then link it to the emails. The relevant collection chosen by the user with drop down button 1828 will then be created and from text box 1830 the user will have the ability to copy the email text. The relevant collection chosen by the user with drop down button 1828 will then be created. By selecting radio button 1829 the user may copy text from the individual email message 1824 and that content will be provided as the feedback. Alternatively, the user may at 1830 enter specific feedback (for example, if the feedback is not immediately obvious from the content of the individual email message 1824).

The collection will then be connected to the EIC which thereby provides a link between a person's profile to the relevant collection in the email.

While all of the above may be carried out by the standalone system and method of the present disclosure, utilizing email or other external work systems utilized in workplaces allows for the collection of data, for example, feedback in relation to an employee or user to be more easily collected and doesn't necessarily require a user to be, for example, directly using a program associated with the system and method of the present disclosure. That is to say that the system and method of the present disclosure may run in the background and appears to seamlessly integrate with the systems that the user's in the workplace use and without much effort required on behalf of the user, are able to capture information regarding the performance of employee's and to provide feedback and/or learning outcomes or training or management of tasks.

FIG. 18c illustrates an example user interface 1800c of the system and method of the present disclosure within an email application 1840. The system and method of the present disclosure includes a work attached people management panel 1841 which appears when an EIC is connected to the emails.

A recent activity section 1842 is provided. For example, user “Victoria Bennett” has recently provided feedback about a particular email that is being viewed. The feedback is shown at 1843. It will be appreciated that a third party may be viewing the user interface 1800c or it may be “Jane Li” or “Victoria Bennett” where, for the particular email that they are viewing (assuming that they have permission to view the collection), the user can see relevant feedback associated with the email. It will be appreciated that it need not be feedback, it may be any other object such as a learning object or task associated with that email.

The feedback provided is via a feedback collection (such as that shown in FIG. 11) that is connected to an EIC which references the email. In this situation only on the user will see feedback 1843 if they are permitted to do so.

Additional feedback or other types of collections may be added using the drop down button 1844. There is an option to allow content of the email to be copied into the collection being created at 1845. By selecting radio button 1845 the user may copy text from the individual email message and that content will be provided as the feedback. Alternatively, the user may at 1846 enter specific feedback (or details relating to learning or a task as the case may be). When button 1847 is clicked or tapped a new collection will be created and/or added to the EIC.

FIG. 19 is a flow diagram illustrating a method for creating templates for use with one or more objects in the present disclosure. The method 1900 includes the steps of 1901 where the user chooses a template object and at step 1902 a new object is generated and the title may be ready from the template and stored in the new object with the text “copy” concatenated. The type name and attachments of the new object are set based on the templates. For example, if the template includes attachments these are also read and stored in the new objects. Control then moves to step 1903 where the views of who initiated the process 1900 is stored in the new object as the subject participant. It is then determined at steps 1904, 1906, 1908, 1910, 1912, 1914 and 1916 what type of object is being created and depending on the type of object whether it is a feedback object, goal object, learning object, skill object, task object, plan object or review object control moves to one of steps 1905, 1907, 1909, 1911, 1913, 1915 or 1917 where information relating to that particular type of object is read into the template and stored. The process is then concluded at step 1918.

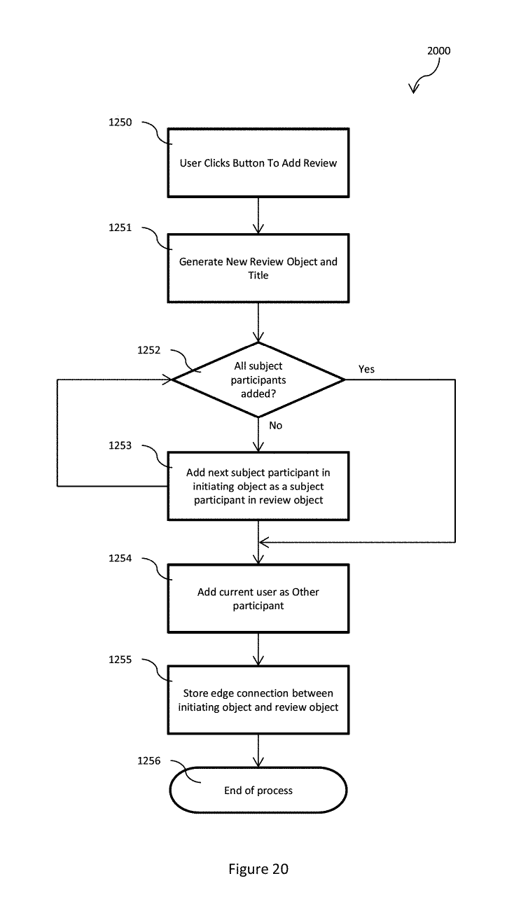

FIG. 20 is a method 2000 illustrating the process where a user chooses to add a review to another object such as a goal object or skill object. At step 1250 the user chooses to add a review to another object and control moves to step 1251 where a new review object is generated and the user sets the title of the review, and the title of the object 1251. Each subject participant in the object must then be added as a participant to the new review object, so control moves to step 1252 where it is determined whether or not all of the participants have been added to the review object and if not control moves to step 1253 where the user is prompted add a participant to the object and control returns to step 1252. In the event that all of the participants have been added controls moves to step 1254 where the user who created the review object is added as an “other participant” since it is likely that the person who is creating the review object is likely to be the reviewer rather than the person being reviewed. Control then moves to step 1255 where the object is initiated as a parent and the review object as a child. This is carried out by making an edge connection and storing the edge connection along with the relationship between the initiating object and the new review object. The process concludes at step 1256.

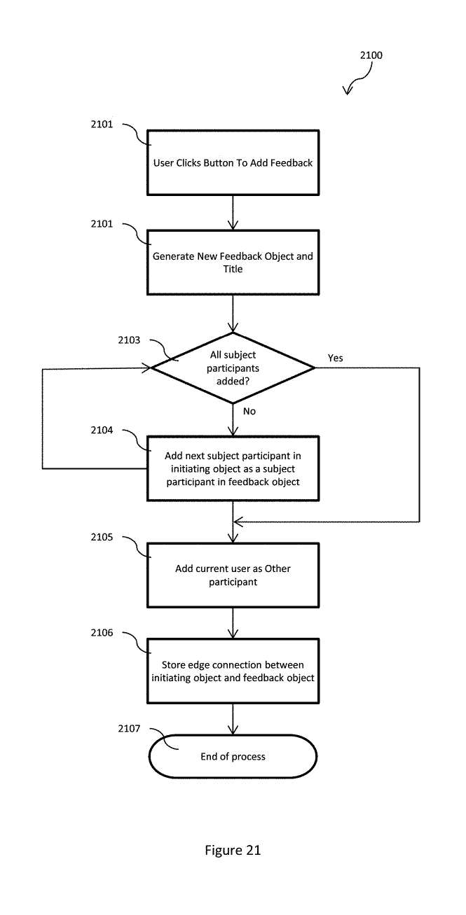

FIG. 21 illustrates a method 2100 of adding a feedback object to another object such as a goal object or a skill object. At step 2101 a user clicks a button to add a feedback object and control moves to step 2102 where a new feedback object is created and the user can set the title of the feedback object. Control then moves to step 2103 where it is determined whether or not all of the participants for the feedback object have been added. If they have not controls moves to step 2104 where the user is provided with the ability to add participants in the feedback object and these participants might be the people who will be receiving feedback and/or the people who will be providing feedback. Control returns to step 2103 until all of the participants have been added at which point control moves to 2105, where the person who created the new feedback object is added as an “other participant”. The reason for this is that the person who creates the object is likely to be the person who is potentially carrying out the feedback. Control then moves to step 2106 where an edge connection is created and stored along with the relationship between the parent object and the new created feedback object. Control then moves to step 2107 where the process concludes.

FIG. 22 is a flow diagram 2200 which illustrates connecting two objects together. At step 1250 the process is initiated and determines whether or not a connection already exists between the two objects to be connected. At step 1251 it is determined whether or not they are already connected. In the event that they are control moves to step 1254 where the process ends otherwise control moves to step 1252 where an edge connection is created using the identifiers of the two objects to be connected. The relationship between the two objects is recorded by signifying one object as a parent and the other object as a child at step 1253. For example, a goal might be “Build a bridge crossing the Ganges river that will have a lifespan of 100 years and be capable of carrying 1 million vehicles per day”. In response, a user might connect a task “Identify experienced civil engineers operating in the area” and so on.

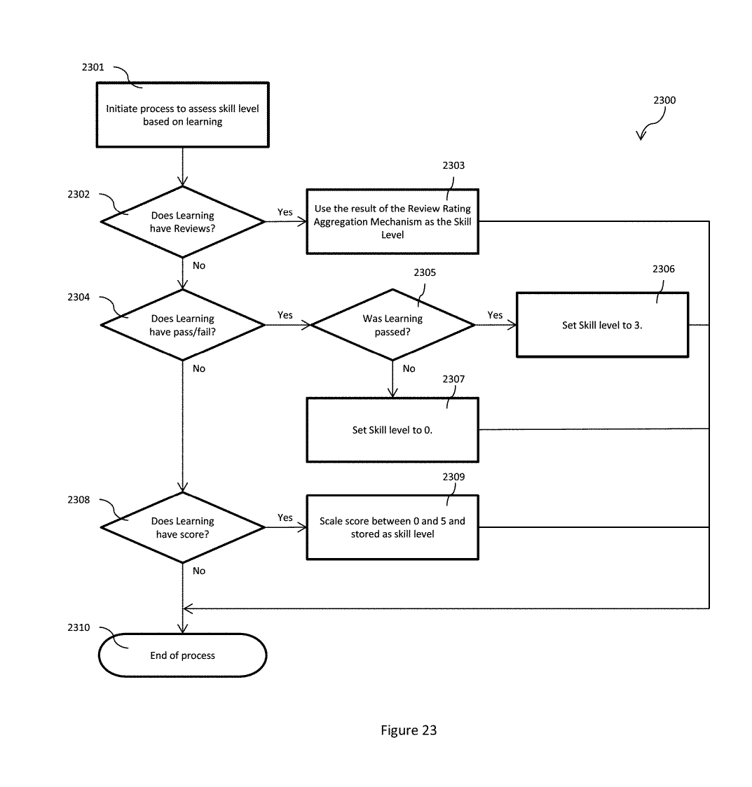

FIG. 23 is a flow diagram 2300 illustrating the process for conducting an assessment of skill based on learning results. At step 2300 the user initiates a process to assess a skill level based on learning, control then moves to step 2302 it is determined whether or not the learning object is connected to a skill object and has connected reviews. In the event that it does control moves to step 2303 where the results of the review rating aggregation mechanism is provided as the skill level and then the process ends at step 2310. Otherwise, control moves to step 2304 where it is determined whether or not the learning object is connected to a skill object that utilizes a pass or fail result (i.e. a yes or no, pass/fail) in the event that it does control moves to step 2305 where it is determined whether or not the learning was a pass or a fail. In the event that it was a pass control moves to step 2306 where a skill level is set to certain level and in this case it is 3 and the process ends at step 2310. In the event the learning at step 2305 was not passed (i.e. failed) control moves to step 2307 where a skill level is set to 0 and control then moves to the end of the process 2310. In the event at step 2304 the learning was not a pass or fail type of learning, control moves to step 2308 where it is determined whether or not the learning is score based. In the event that it is not score based, control moves to the end of the process 2310, otherwise control moves to step 2309 where a scale score is provided between a particular level and stored. It will be appreciated that any type of score arrangement may be provided.

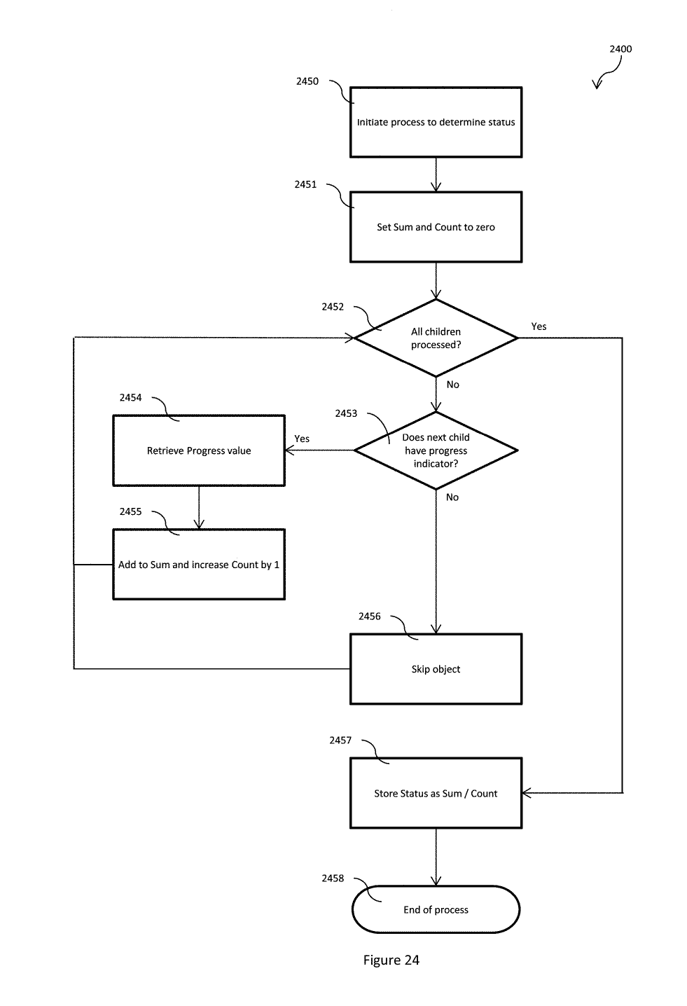

FIG. 24 is a flow diagram 2400 illustrating the process for determining the status of a collection passed on the progress of any child connected objects to 2450. The method 2400 starts by setting two variables to zero, Sum and Count 2451. Control then moves to step 2452 where all child objects of the current object are processed. For each child object, if the object uses a progress indicator at step 2453 the value of that indicator is retrieved at step 2454 and added to the sum variable 2455. The count is increased by 1 to track the total number of child objects with progress indicators 2455. Child objects without progress indicators are skipped and not included in the sum or count 2456.

Status can then be calculated as the result of the division of the total sum by the total count 2457. The process then concludes at 2458.

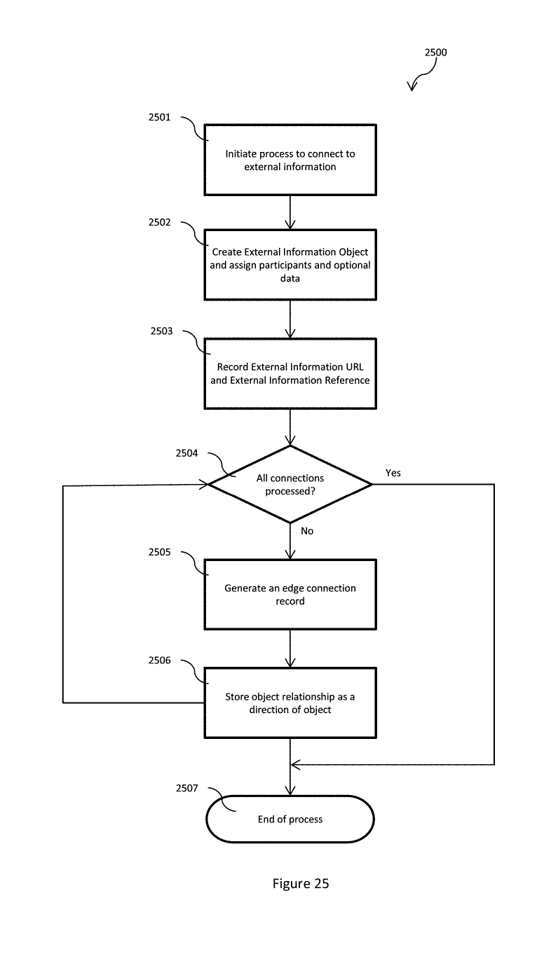

FIG. 25 is a flow diagram 2500 illustrating the process for when a user or developer initiates a connection to external information 2501. A new object of the type External Information Object is created at step 2502 and at least one participant must be assigned. The developer or user may then optionally add data such as dates, description and attachments and the like as was described with reference to the “API Mechanism” described above.

A step 2503 reference to the external information and a URL (if available) is recorded. At step 2504 it is determined whether or not all connections have been processed, assuming the developer wants to connect the object to other objects. And for each connection, an edge connection record is stored 2505. The direction of the connection is also stored as either child or parent 2506. The process is then concluded 2507.

FIG. 26 is a flow diagram 2600 which illustrates the process followed to aggregate Review collection ratings 2650. This process is used in the People Profile Reviews section and can also be used in other object, such as the Goal object, when reviews need to be aggregated. The process starts at step 2651 by setting two variables Sum and Count to zero. Then, starting from the originating object, that is, the one in which the reviews are to be aggregated, all child nodes are traversed to build a list of objects to be processed 2652. Child nodes are traversed until either the entire tree has been traversed from the originating object, or the originating object is encountered. If the originating object is encountered this is a circular reference.

Each object in the reviews list is then processed at step 2653 and for each review object the rating is mathematically scaled at step 2654 between 0 and 5 (but it will be appreciated that any particular type of rating may be provided). The resulting scaled rating is added to the Sum and the Count is increased by one at step 2655. The aggregate can then be calculated as the result of the division of the total Sum by the total Count 2656. The process then concludes 2657.

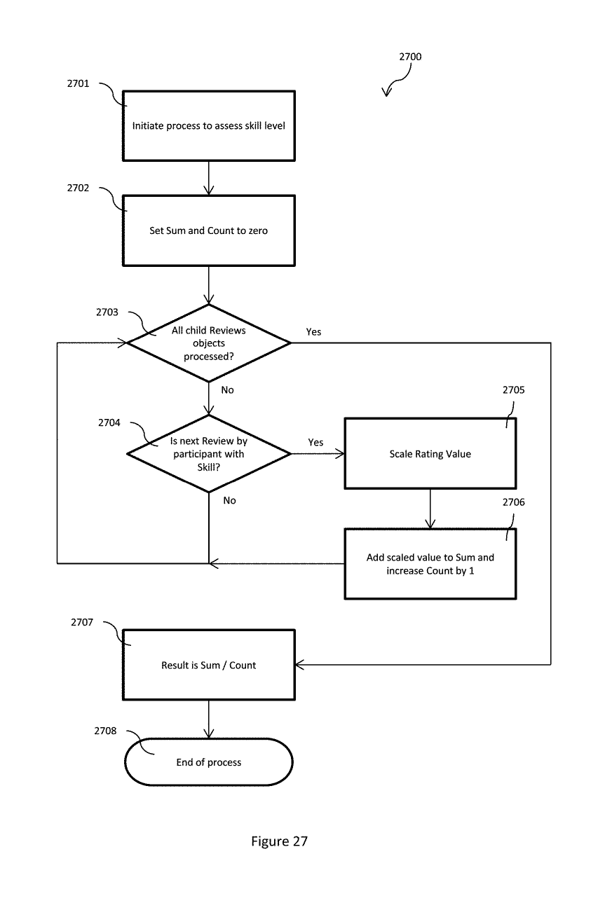

FIG. 27 is a flow diagram 2700 illustrating the process for skill assessment at step 2701. A skill level to be assessed is provided and then control moves to step 2702 in which two variables Sum and Count are set to zero. Then, starting from the current skill object, all immediate child review objects are processed at step 2703 and for each review object, if the Review Conducted By Participant holds the Skill being assessed 2704, the Review rating is mathematically scaled 2705 between 0 and 5. It will be appreciate that any scale may be provided. A step 2706 the result is added to the Sum and the Count increased by one.

The skill level can then be calculated as the result of the division of the total Sum by the total Count at step 2707. The process then concludes 2708.

FIGS. 28 and 29 illustrate People Profile Learning section suggestions where two components are required to provide the learning suggestions, the first being to track learning template usage and the second being to evaluate popularity and make the learning suggestion.

FIG. 28 is a flow diagram 2800 illustrating the method for Learning template usage tracking and by tracking usage it is possible to determine the most popular Learning objects. The method 2800 starts by a user choosing to use a Learning template object at step 2850 and at step 2851 the Use Template Mechanism 2851 completes the processing needed to create a new Learning object based on the template. Each Learning collection template contains records showing how many times the template has been used in a given period (for example, a month, 6 months, 1 year or the like). At Step 2852 it is determined whether or not a record for the current month exists and if it does not control moves to step 2853 where a counter record is created and the usage counter for the current month is incremented at step 2854 by one. The process then concludes at step 2855.

FIG. 29 is a flow diagram 2900 illustrating the method for providing learning suggestions 2901. The process starts by retrieving an ordered list of Learning template objects 2902, which is sorted on highest usage counter values over a predetermined time period (for example 12 months). This information may be obtained from the method provided in FIG. 28 for example. At step 2903 a predetermined number of learning suggestions needs to be provided before control can move to step 2904. For example, 5 learning suggestions might the predetermined threshold but it could be more. At step 2904 it is determined whether or not all of the Learning templates have been considered, control moves to step 2905. In the event that a user does not already have a learning object based in the template 2906 it is added to the Learning suggestions list 2907 and the process then concludes 2908.

Further aspects of the method will be apparent from the above description of the system. Persons skilled in the art will also appreciate that the method could be embodied in program code. The program code could be supplied in a number of ways, for example on a tangible computer readable medium, such as a disc or a memory or as a data signal or data file (for example, by transmitting it from a server).

It is to be understood that various alterations, additions and/or modifications may be made to the parts previously described without departing from the ambit of the present disclosure, and that, in the light of the above teachings, the present disclosure may be implemented in software, firmware and/or hardware in a variety of manners as would be understood by the skilled person.

The discussion of documents, acts, materials, devices, articles and the like is included in this specification solely for the purpose of providing a context for the present disclosure. It is not suggested or represented that any or all of these matters formed part of the prior art base or were common general knowledge in the field relevant to the present disclosure as it existed before the priority date of each claim of this application.

What is claimed is:

1. A computer implemented method of managing information between users, the method including:
a. providing one or more People Management Objects (PMO's), the PMO's including one or more users, and the PMO's adapted to collect information from the one or more users;
b. associating the PMO's with one or more additional PMO's; and
c. outputting the PMOs for the users to participate.

2. The method of claim 1, wherein associating includes connecting, via an edge connection the one or more PMOs to one or more further PMO's.

3. The method of claim 1, wherein associating further includes creating a relationship between one or more PMOs to one or more further PMO's.

4. The method of claim 1, wherein the relationship includes a parent-child relationship.

5. The method of claim 1, further including the step of reproducing one or more objects for use in a separate PMO.

6. The method of claim 1, further including aggregating data from one or more PMO's.

7. The method of claim 6, wherein data is aggregated between one or more PMO's.

8. The method of claim 6, wherein data is aggregated between one or more PMO's and a user profile.

9. The method of claim 1, wherein a PMO includes any one or more of a Goal MO, Review MO, Skill MO, Feedback MO or Learning MO.

10. The method of claim 1 further including the step of providing one or more Work Objects.

11. The method of claim 11 further including the step of associating a PMO with the one or more Work Objects.

12. The method of claim 12, wherein associating further includes creating a relationship between one or more PMOs to Work Objects.

13. The method of claim 11, wherein a Work Object further includes one or more of a Conversation, Task or Plan.

14. The method of claim 1 further including the step of providing External Information.

15. The method of claim 14 further including the step of associating a PMO with External Information.

16. The method of claim 14, wherein External information includes one or more of a description of the external information, external information URL and/or an external information reference.

17. The method of claim 1, wherein each of the Goal MO Review MO, Learning MO, Skill MO and Feedback MO, includes a title, subject participants, other participants, one or more attachments, one or more discussions and one or more connections one or more other PMO's.

18. The method of claim 17 wherein the one or more connections are parent, child, undirected connections.

19. The method of claim 1, wherein special purpose data includes one or more of start dates and end dates review, rating, recognition, rich memo supporting formatted text, tables, pictures, video, description, measures, progress indicator, outcomes, learning content, evidence requirements, assessment criteria, notes, status, external information reference, or a URL.

20. The method of claim 1, wherein a Goal MO further includes one or more of Goal description, Target Date, Measurement and Progress Indicator.

21. The method of claim 1, wherein a Feedback MO further includes a Feedback memo supporting formatted text, tables, pictures and video and a feedback type.

22. The method of claim 1, wherein a Review MO further includes a rich memo supporting formatted text, tables, pictures, video, a rating or numerical result.

23. The method of claim 1, wherein a Learning MO further includes a description of learning, outcomes description, progress indicator, learning content memo supporting formatted text, tables, pictures, video.

24. The method of claim 23, wherein the Learning MO further includes links to industry standard eLearning content, wherein the eLearning content includes SCORM, AICC and TinCan.

25. The method of claim 1, wherein a Skill MO further includes, a skill description, a metric for skill demonstration, learning required to develop the skill, specification for skill assessment.
